(19) United States
(12) Patent Application Publication
(10) Pub. No.: US 2004/0080534 A1
(43) Pub. Date: Apr. 29, 2004

(54) Front Message exchange system and method

(76) Inventor: Douglas A. Quach, Richardson, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/431,419

(22) Filed: May 7, 2003

Related U.S. Application Data
(60) Provisional application No. 60/378,835, filed on May 7, 2002.
(60) Provisional application No. 60/386,461, filed on Jun. 5, 2002.
(60) Provisional application No. 60/386,463, filed on Jun. 5, 2002.
(60) Provisional application No. 60/409,486, filed on Sep. 10, 2002.

(51) Int. Cl. G09G 5/00

(52) U.S. Cl. 345/751

(57) ABSTRACT

In accordance with an embodiment of the present invention, a method for enabling communications between members of a group comprises enabling a first member of the group to post a public electronic message and enabling the first member to assign the message to a second member of the group for handling.

### CROSS-REFERENCE TO RELATED APPLICATIONS

This patent application claims the benefit of Provisional Patent Application, Serial No. 60/378,835, entitled Front Message Exchange System, filed on May 7, 2002; Provisional Patent Application, Serial No. 60/386,461, entitled System and Method for Providing Recent Viewing Information for Members of a Group, filed on Jun. 5, 2002; Provisional Patent Application, Serial No. 60/386,463, entitled System and Method for Members of a Group to Share Information, filed on Jun. 5, 2002; and Provisional Patent Application, Serial No. 60/409,486, entitled New Nation-Building Communication Infrastructure, filed on Sep. 10, 2002; the disclosures of all of which are incorporated herein by reference.

### TECHNICAL FIELD OF THE INVENTION

The present invention relates generally to the field of electronic messaging, and more particularly to a front message exchange system and method.

### BACKGROUND OF THE INVENTION

An electronic mail (“email”) system may be an online or web-based email system which allows a user to send email messages from any location or computer or it may be a private email system which allows the user to send email messages from only specific locations or computers. An email message is a private message sent to one or more private inboxes for viewing and disposal by the specified recipient(s). Even if the email message has been broadcast to multiple recipients, each recipient may do as he/she wishes with his/her copy of the email message. The inbox owner can read the message or choose to delete the email message without reading its contents. The true disposal status of the email message is unknown to everyone except the inbox owner. Because email is a private communication, when an important email message directed to a particular person is sent, no one but the recipient knows about the email message or whether the recipient took any action with regard to the email message. Furthermore, if the email message was sent to multiple recipients, more than one person may reply at different times which results in multiple reply messages sent to just the message originator or to all the recipients. The email recipients have to sort out all the reply messages to determine a chronological order so that the messages may be put in context of the other messages.

### SUMMARY OF THE INVENTION

In accordance with an embodiment of the present invention, a method for enabling communications between members of a group comprises enabling a first member of the group to post a public electronic message and enabling the first member to assign the message to a second member of the group for handling.

In accordance with another embodiment of the present invention, a method comprises receiving from a member of a group a request for a list of pubic electronic messages assigned to members of the group and providing the list to the member of the group.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of a front message system;

FIG. 2 is a block diagram of a front message exchange system in accordance with an exemplary embodiment of the present invention;

FIG. 3 is a flowchart of a method for posting a new topic in accordance with an embodiment of the present invention;

FIG. 4 is a flowchart of a method for displaying a doorknob of a user in accordance with an embodiment of the present invention;

FIGS. 5A and 5B are flowcharts of a method for posting a reply to a posted topic, editing an initial posting or editing a posted reply in accordance with an embodiment of the present invention;

FIG. 6 is a flowchart of a method for displaying a front message and its associated replies;

FIG. 7A is a screen shot of an exemplary user-interface for posting a new message;

FIG. 7B is a screen shot of an exemplary user-interface for accessing a doorknob;

FIG. 7C is a screen shot of an exemplary user-interface displaying all items currently assigned to a user;

FIG. 7D is a screen shot of an exemplary user-interface for replying to a front message;

FIG. 7E is a screen shot of an exemplary user-interface displaying a front message and its associated replies;

FIG. 7F is a screen shot of an exemplary user-interface displaying all unclosed front messages;

FIG. 7G is a screen shot of an exemplary embodiment user-interface displaying all unclosed front messages assigned to a selected user;

FIG. 7H is a screen shot of an exemplary embodiment user-interface displaying all unclosed front messages originated by the user;

FIG. 8 is a screen shot of an exemplary embodiment user-interface for geographic shopping;

FIG. 9 is a screen shot of an exemplary embodiment user-interface for recent viewing;

FIGS. 10A-10G are screen shots of an exemplary embodiment user-interface for sharing of information;

FIGS. 11A-11C are screen shots of an exemplary embodiment user-interface for all local talk;

FIGS. 12A and 12B are screen shots of an exemplary embodiment user-interface for browser notes;

FIGS. 13A-13C are screen shots of an exemplary embodiment user-interface for casual messages;

FIGS. 13D-13E are screen shots of an exemplary embodiment use-interface for commitment messages;

FIG. 14 is a screen shot of an exemplary embodiment user-interface for integrity check;

FIG. 15 is a screen shot of an exemplary embodiment user-interface for displaying information on recent viewers of a profile;

FIG. 16 is a screen shot of an exemplary embodiment user-interface for displaying a diary;

FIG. 17 is a screen shot of an exemplary embodiment user-interface for a front request;

FIG. 18 is a screen shot of an exemplary embodiment user-interface for displaying a user snapshot; and

FIG. 19 is a screen shot of an exemplary embodiment user-interface for podium messaging.

### DETAILED DESCRIPTION OF THE DRAWINGS

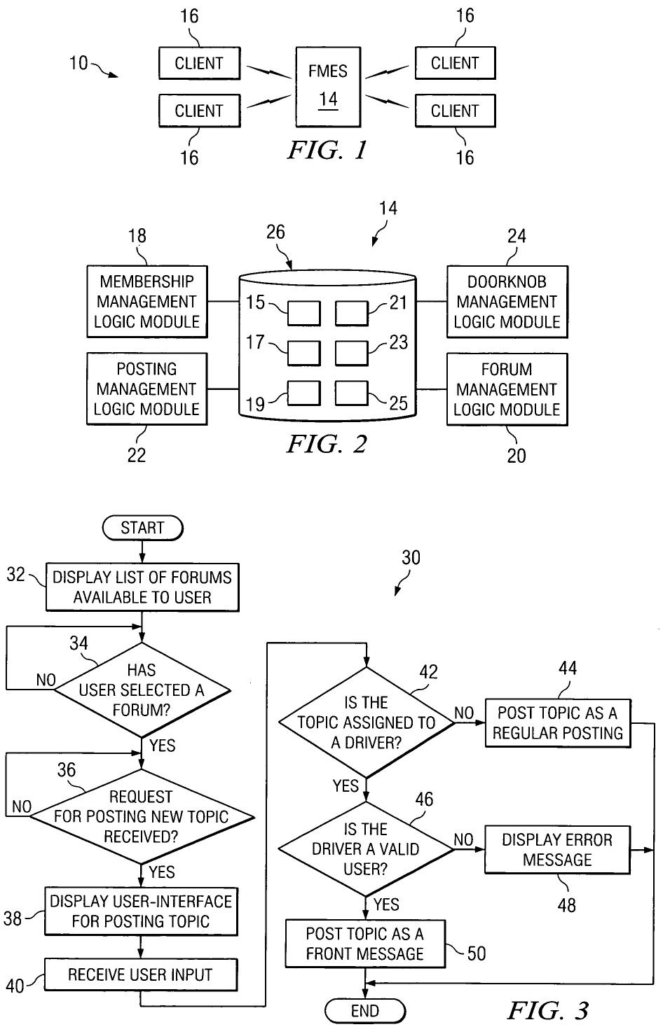

The preferred embodiment of the present invention and its advantages are best understood by referring to FIGS. 1 through 19 of the drawings, like numerals being used for like and corresponding parts of the various drawings.

FIG. 1 is a block diagram of a front message system 10 which may use embodiments of the present invention to advantage. System 10 comprises a front message exchange server (FMES) 14. FMES 14 preferably acts as a web server and may also serve as a repository for certain data and programs. FMES 14 may be any computing device such as a network computer running a network operating system. FMES 14 preferably includes conventional web hosting operating software and includes a device for connecting with the Internet such as a dial-up modem, a cable modem, a wireless modem, a wireless gateway, a xDSL modem, or ISDN converter. FMES 14 is preferably under the control of a provider of a messaging service, for example a provider of electronic mail (“email”) services or message board services.

One or more client computer(s) 16 may be networked with FMES 14 via a communication network (not shown). Each client computer 16 is preferably a processor based device, such as a personal computer (PCs), a workstation, a laptop computer, a personal data assistant (PDA), a wireless phone, and/or the like, that may be used by a user, such as a member of a group or community. Client computer 16 may be a stand-alone device or multiple computers may be networked together via a communication network (not shown). Each client computer 16 preferably includes a device such as a dial-up modem, a cable modem, a wireless modem, a wireless gateway, a xDSL modem, or ISDN converter. Client computer 16 preferably comprises a user-interface, for example a web browser, for accessing FMES 14. Client computer 16 may be used by a user to interact with other members of the group via FMES 14.

In accordance with an embodiment of the present invention, FMES 14 enables creation of trust and collaboration among members of a group or community. In an exemplary embodiment, FMES 14 enables creation of a web based message board system comprising of a plurality of forums or message boards. However, the invention is not so limited, and if desired, the teachings of the present invention may be used with other types of messaging technologies, such as email etc. FMES 14 enables the members of a group of entities or people to send and receive electronic messages called “front messages”. A “front message” is a public message assigned to a member of the group. The member to which the front message is assigned is referred to herein as a “driver” of the message. The driver of a front message is responsible for handling or processing the front message. A front message is accessible by all the members of the group. Each member preferably has an electronic front doorknob associated with him/her. Front messages assigned to a driver are said to be “hung” on his/her doorknob. The electronic front doorknob of each member is preferably accessible by other members of the group. Thus, a member's reputation in the group is established based on how the member issues and/or handles front messages in dealing with other members of the group. The group represents a community which may be geographically or organizational based, such as a school, a community, a city, a state, or a region, or the community may be based on interests, hobbies, professions, ideals, etc.

In an exemplary embodiment, FMES. 14 comprises one or more forums or message boards. However, a front message is not the same as a posting on a message board. A conventional posting to a message board is not assigned to any particular member of the group and it cannot be passed around. A posted message has an endless life, i.e., a member can reply to a posting at any time. In contrast, the life of a front message is over when it is brought to a closure by the driver. A front message may be passed around from one member of the group to another for handling. Thus, the same front message may have different drivers at different times. Preferably, at any given time, only one driver is assigned to a front message. The driver of a front message may be an individual member of the group or a sub-group within the group.

Because the front doorknobs of members are visible to all in the group, members establish or maintain their reputation by demonstrating to other members how front messages are issued and handled by them. For example, if a member is always very quick to respond to front messages hung on his doorknob, he may develop a reputation as being very responsive. However, if a member neglects front messages hung on his doorknob that member may develop a reputation as being non-responsive. This could bring about an immediate trust between members of the group. The enabling of immediate trust facilitates intimate collaboration by and for members of the group. Intimate collaboration may be achieved when cooperation among the members of the community results in productivity similar to that achieved by members of a small and close community.

An intimate community is a community in which groups can achieve intimate collaboration. FMES 14 facilitates the creation of intimate communities. An example of an intimate community may be a school. Using FMES 14, a school may have a more close-knit student body, more loyal alumni and better informed and involved parents. The ability to communicate and collaborate using the front message system breaks down geographical, personal and organizational boundaries and results in a better informed and closer community.

Intimate collaboration done on a large scale can give rise to electronic politics, which is the speedy creation and promotion of new economic and social communities within a city, a school district, a state, region, etc. Electronic politics could introduce significant changes to most of our current economic and social organizations.

To enable electronic politics, FMES 14 optimizes many-to-many communication. Students from one school could quickly understand students from another school at the start of a school year such that collaborative efforts on cross-school projects could be completed within the school year. Engagement between two cities or two nations at citizenry level could be envisioned. Cross-community, nation building and other front message applications could summon a new wave of Internet successes and thereby kick start what comes after the information age: the community age. In the community age, FMES 14 can give a community an edge over its competitors.

FIG. 2 is a block diagram of FMES 14 in accordance with an exemplary embodiment of the present invention. FMES 14 comprises a membership management logic module 18, a forum management logic module 20, a posting management logic module 22 and a doorknob management logic module 24, all of which being communicatively coupled to a database 26. The operations of these logic modules are described in detail below. In alternative embodiments, one or more of the modules could be external to FMES 14, if desired. Moreover, one or more of the modules could be combined into a single module, if desired.

Database 26 comprises information regarding the members of the forums. Database 26 preferably comprises a plurality of tables, for example a members table 15, a forums table 17, a message type table 19, a message status table 21, a topics table 23, a replies table 25, and/or the like. If desired, one or more of the tables may be combined into a single table. Members table 15 includes information about the members. Preferably, for each member there is a separate record in members table 15. Each record may include one or more of the following fields: a member ID field uniquely identifying the member, a username field for the username of the member, a member password field for the password of the member, an email address field for the email address of the member, and/or the like.

Forums table 17 includes information about various forums that may be supported by FMES 14. The term “forum” and “message board” are used interchangeably herein. Preferably, for each forum there is a separate record in forums table 17. Each record includes the following field: a forum ID field uniquely identifying the forum, a forum title field for the name of the forum, and/or the like.

Message type table 19 includes information about the different types of messages that may be posted on the message boards and their associated message type ID. The messages may be driverless or not driverless. A front message is not driverless. A front message may be of different types, for example QUESTION, ISSUE, STORY, REQUEST, FYI, and/or the like. Table I is an message type table.

TABLE I

| ID | NAME |
|---|---|
| 1 | Driverless |
| 2 | Question |
| 3 | Issue |
| 4 | Story |
| 5 | Request |
| 6 | FYI |

Message status table 21 includes information about different types of message status their associated message status ID. During its life, a front message preferably has at least a New status and a Closed status. A front message may have one of the following status at any given time, for example CLOSED, NEW, REASSIGNED, PENDING, WORKING, FINISHED, and/or the like. Table II is an exemplary message status table.

TABLE II

| ID | NAME |
|---|---|
| 1 | Closed |
| 2 | New |
| 3 | Reassigned |
| 4 | Pending |
| 5 | Working |
| 6 | Finished |

When a front message is first created, its status is NEW. Thereafter, its status may be changed, for example to REASSIGNED if the driver assigns the front message to someone else in the group, PENDING if the driver needs more information to properly handle the front message, WORKING if the river is handling the front message, FINISHED if the driver has finished handling the front message and assigned it to someone else for verification, and CLOSED if the driver desires to close the front message and remove it from his doorknob. Table III summarizes the changes that may be made to a front message and/or posted replies depending on the current status of the front message in accordance with an exemplary embodiment of the present invention.

TABLE III

| CURRENT | | |
|---|---|---|
| STATUS | STATUS CHANGES | OTHER CHANGES |
| Closed | No one may change the | No changes may be made to |
| | status of the front message | any part of the front |
| | | message or replies. |
| New | Any member of the forum | Text of front message or |
| | can change the status of the | replies cannot be changed. |
| | front message | EXCEPTION: Person who |
| | | supplied text last may |
| | | modify the last text. |
| Reassigned | Any member of the forum | Text of front message or |
| | can change the status of the | replies cannot be changed. |
| | front message | EXCEPTION: Person who |
| | | supplied text last may |
| | | modify the last text. |
| Pending | Only driver can change the | Text of front message or |
| | status of the front message | replies cannot be changed. |
| | | EXCEPTION: Person who |
| | | supplied text last may |
| | | modify the last text. |
| Working | Only driver can change the | Text of front message or |
| | status of the front message | replies cannot be changed. |
| | | EXCEPTION: Person who |
| | | supplied text last may |
| | | modify the last text. |
| Finished | Only driver can change the | Text of front message or |
| | status of the front message | replies cannot be changed. |
| | | EXCEPTION: Person who |
| | | supplied text last may |
| | | modify the last text. |

Topics table 23 includes information about various topics being discussed within the communities. Preferably, for each topic there is a separate record in topics table 23. Each record may include one or more of the following fields: a topic ID field uniquely identifying the topic; a topic date field for the date the topic is first posted; a topic subject field for the subject of the topic; a topic body field for the body of the topic; a forum ID field for indicating the forum in which the topic is posted; a message type ID field for indicating the type of the message; a message status ID field for indicating the status of the message; a driver ID field for indicating the ID of the member who is the current driver of the topic; and a topic author ID field for indicating the ID of the member who originated the topic. A new topic posting may be driverless or not driverless. If a new topic posting is driverless, then the posting is like a regular posting on a message board. Otherwise, it is a front message.

Replies table 25 includes information about various replies posted in response to the topics. For each topic there may be one or more replies. Preferably, for each reply there is a separate record in replies table 25. Each record may include one or more of the following fields: a reply ID field uniquely identifying the reply; a reply date field for the date the reply is posted; a reply body field for the body of the reply; a forum ID field indicating the forum in which the reply is posted; a topic ID field identifying the topic with which to associate the reply; and a reply author ID field indicating the ID of the member who posts a reply.

Membership management logic module 18 may be used to register a new member and allow a user to login. The process of registering a new member and allowing a user to login is known and will not be described in detail herein. If desired, a member may change his or her information, such as username, password, email address, etc. However, preferably the member ID, which uniquely identifies the member, cannot be changed by the member.

Forum management logic module 20 may be used to perform functions associated with managing a message board. One or more tasks may be performed by forum management logic module 20, such as, enabling a user to register a new forum, enabling a user to view a list of forums, enabling a user to open a forum, enabling a user to view a posting, and/or the like. Since the operations associated with managing a forum are known, they will not be described in detail herein.

Posting management logic module 22 may be used to perform functions associated with managing postings of topics, including postings of front messages, and their replies. One or more tasks may be performed by posting management logic module 22, such as, enabling a user to post a new topic, enabling a user to reply to a posted topic, enabling a user to reassign a front message, enabling a user to close a front message, enabling a user to revise a posted topic or a posted reply, enabling a user to change the type of a message from not driverless to driverless, and/or the like.

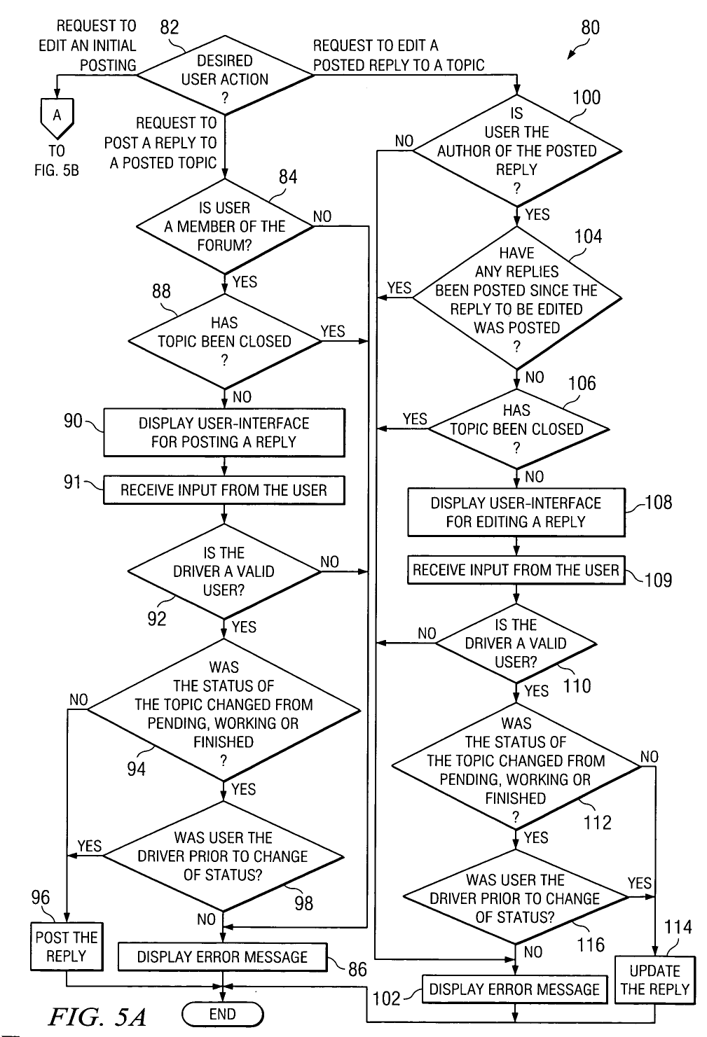

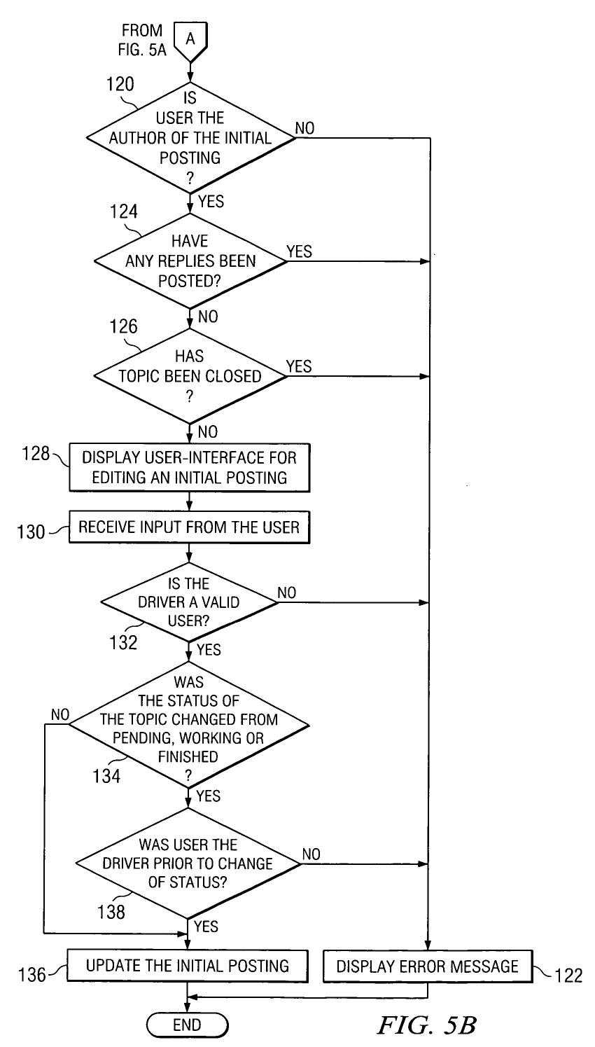

An exemplary method for enabling a user to post a new topic is discussed in detail herein with reference to FIG. 3. An exemplary method for enabling a user to reply to a topic, to close a front message, to change the type of a message from not driverless to driverless, to reassign a front message or to revise a posted topic or a posted reply, is discussed in detail herein with reference to FIGS. 5A and 5B.

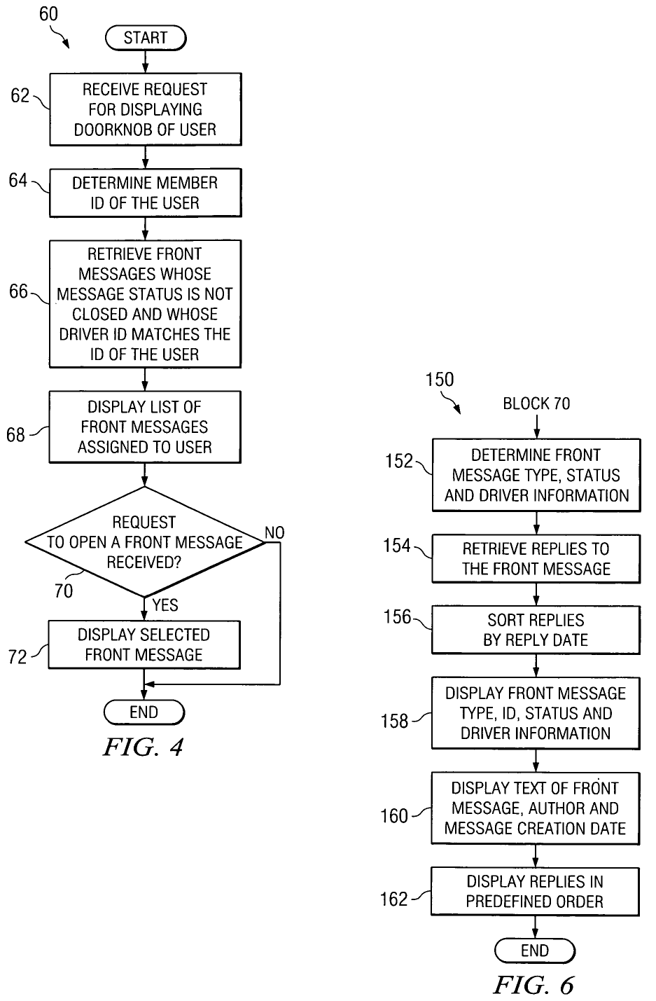

Doorknob management logic module 24 may be used to perform functions associated with managing an electronic doorknob of one or more of the users. One or more tasks may be performed by doorknob management logic module 24, such as, enabling a user to view its doorknob, enabling a user to view a front message, and/or the like. An exemplary method for enabling a user to view its doorknob is discussed in detail herein with reference to FIG. 4. An exemplary method for enabling a user to view a front message is discussed in detail herein with reference to FIG. 6.

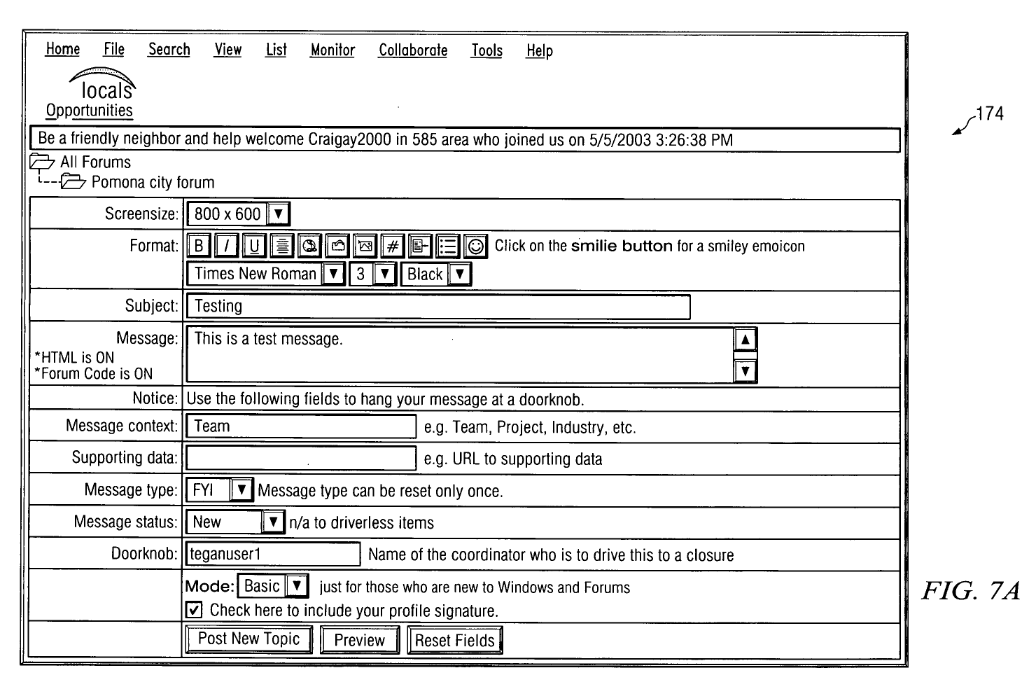

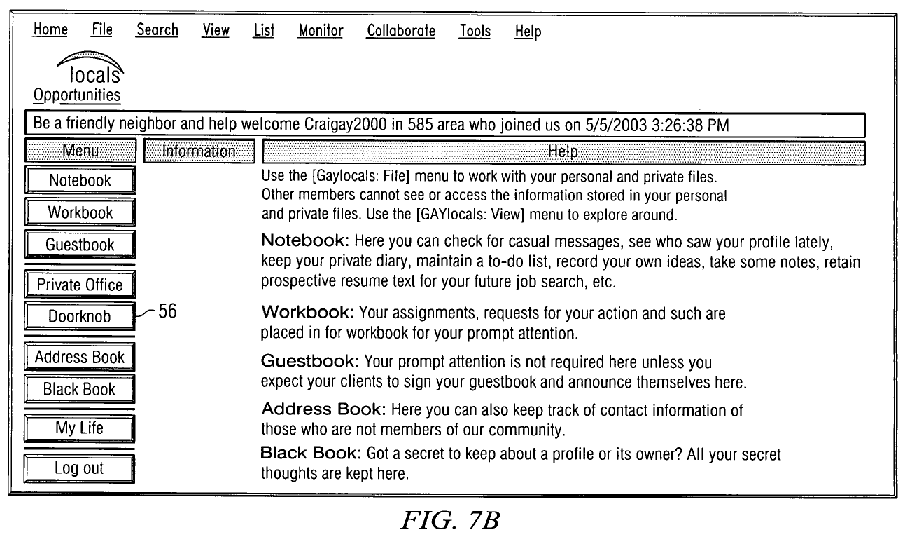

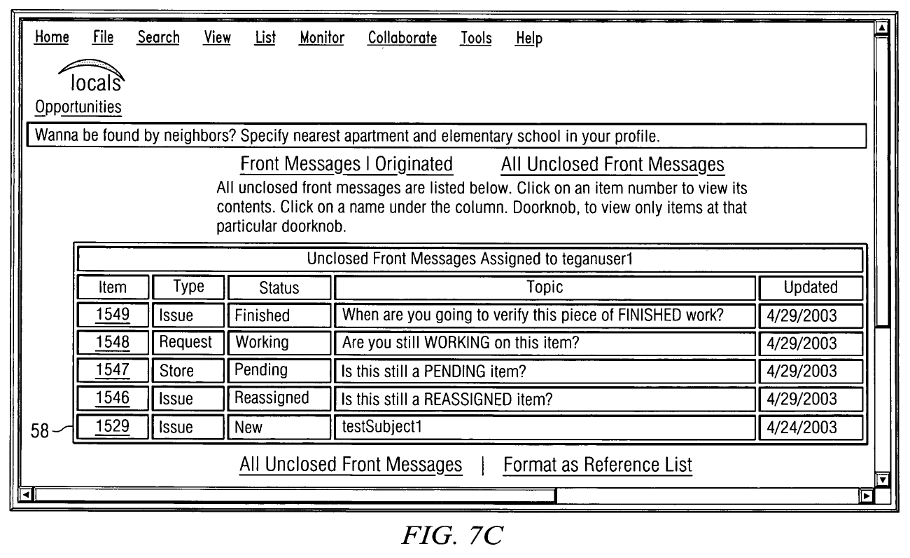

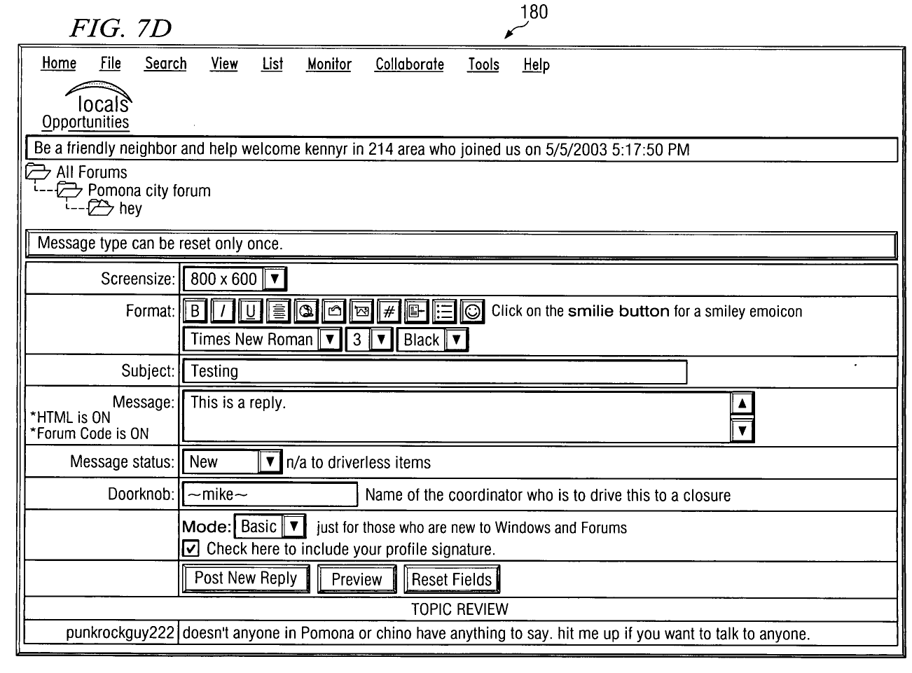

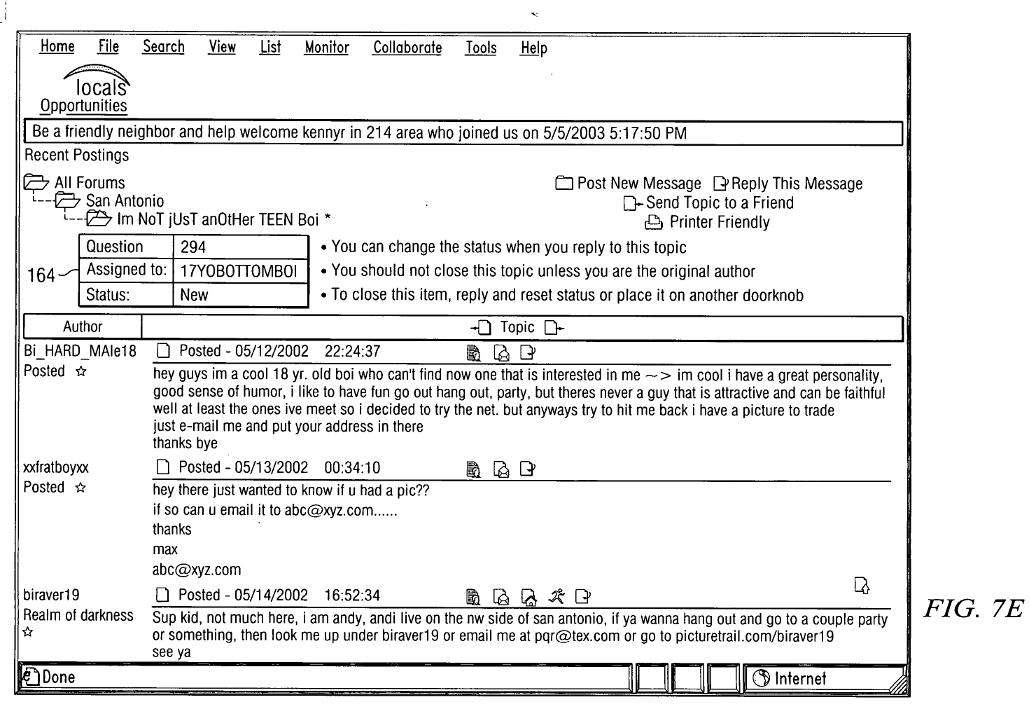

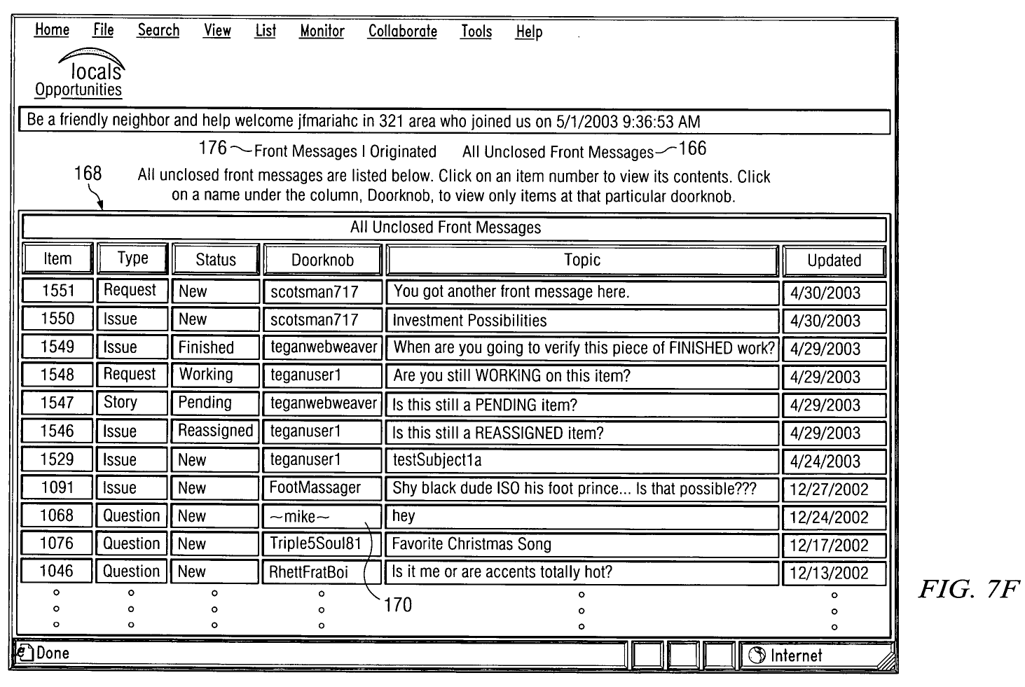

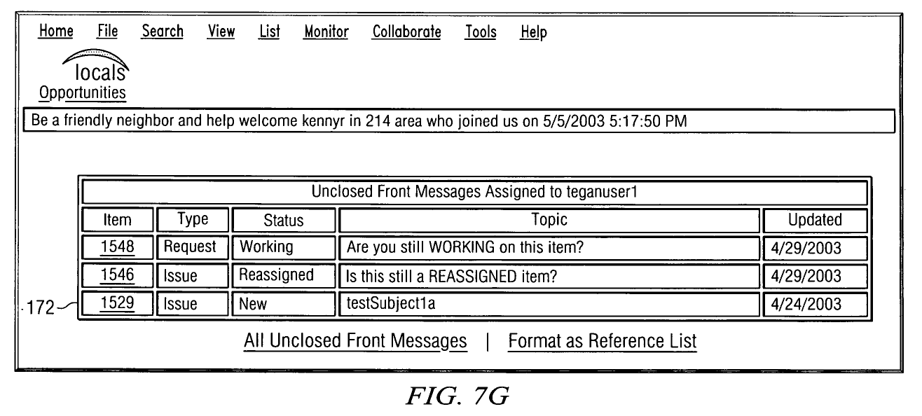

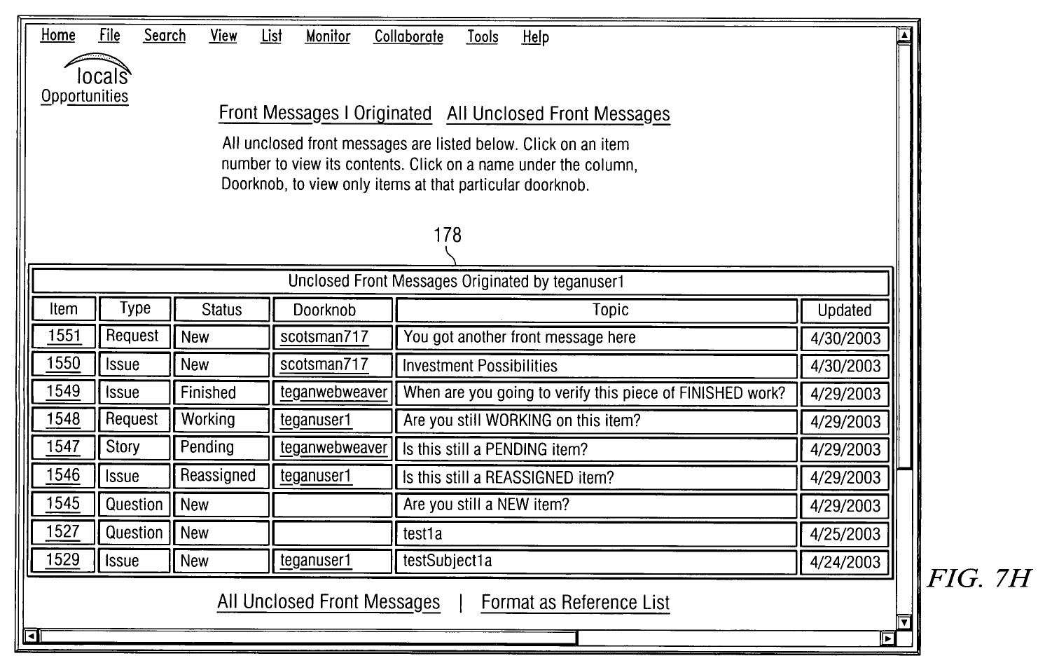

FIG. 3 is a flowchart of a method 30 for posting a new topic in accordance with an embodiment of the present invention. In block 32, a list of forums available to the user is displayed. In block 34, a determination is made as to whether the user has selected a forum. If the user has selected a forum, then in block 36, a determination is made as to whether a request for posting a new topic has been received from the user. If a request for posting a new topic has been received, then in block 38, a user-interface for posting a new topic is displayed. If desired, the user-interface may be a graphical user-interface. An exemplary user-interface 174 for posting a new topic is shown in FIG. 7A. As shown in FIG. 7A, the user may input one or more of the following information: a topic subject, a topic body, a message type, a message status, a driver for the topic, and/or the like. If desired, the user may assign himself or someone else as the driver for the topic. If desired, user-interface 174 may be pre-populated with default values, such as “Driverless” for message type and “New” for message status.

In block 40 (FIG. 3), user-input is received. A posting may be a regular posting or a front message depending on whether it is driverless or not driverless respectively. As such, in block 42, a determination is made as to whether the topic has been assigned to a driver for handling. This determination may be made, for example by determining whether the message type is driverless. If the message type is driverless, then the topic has not been assigned to a driver and the topic is posted in the forum as a regular posting (as shown in block 44) and the process terminates. A record for the new posting is added to topics table 23 (FIG. 2). In the new record, the driver ID field is assigned a value of zero, the message status ID field is assigned a value of zero, the message type ID field is assigned an ID corresponding to a DRIVERLESS message, and the topic author ID field is assigned the ID of the user posting the new topic. Other fields in the new record may be assigned appropriate values.

If the message type is not driverless, then in block 46 (FIG. 3), a determination is made as to whether the username of the user designated as the driver is a valid username. This determination may be made by comparing the username with those in members table 15 (FIG. 2). If the usermame of the driver is not a valid username, then in block 48 an error message may be displayed and the process terminates. Otherwise in block 50 (FIG. 3), the topic is posted as a front message and the process terminates. A record for the new posting is added to topics table 23 (FIG. 2). In the new record, the driver ID field is assigned the ID of the driver, the message status ID field is assigned an ID corresponding to a NEW message, the message type ID field is assigned an ID corresponding to one of the non-driverless message type depending on the selection made by the user, and the topic author ID field is assigned the ID of the user posting the new topic. Other fields in the new record may be assigned appropriate values.

FIG. 4 is a flowchart of a method 60 for displaying a doorknob of a user in accordance with an embodiment of the present invention. Using method 60, a list of all items currently assigned to the user may be displayed to the user. The user may request that all items, such as front messages, associated with his doorknob be displayed by selecting a doorknob icon 56 from a user-interface, such as one shown in FIG. 7B. In block 62 of FIG. 4, a request for displaying the doorknob of the user is received. In block 64, the ID of the user is determined. The ID may be determined, for example, by matching the user's username with records in members table 15 (FIG. 2). In block 66 (FIG. 4), the front messages whose message status is other than CLOSED and whose driver ID matches the ID of the user are retrieved from topics table 23 (FIG. 2). In block 68 (FIG. 4), the retrieved front messages are displayed. FIG. 7C is a screen shot of an exemplary user-interface displaying all items currently assigned to the user. In FIG. 7C, a table 58 provides a list of all items associated with the doorknob of the user. In the illustrated embodiment, table 58 includes the topic ID of the message, the message type, the message status, the topic subject and the date the topic was last updated. If desired, table 58 may display a fewer or greater number of fields. In block 70 (FIG. 4), a determination is made as to whether a request for opening a front message has been received. The user may open a front message by clicking on the topic ID of the displayed message. If a request for opening a front message has not been received then the process terminates. Otherwise, in block 72, the selected front message and its associated replies, if any, are displayed. The process of displaying a front message along with its associated replies is discussed in detail herein with reference to FIG. 6.

FIGS. 5A and 5B are flowcharts of a method 80 for posting a reply to a topic, editing an initial posting or editing a posted reply in accordance with an embodiment of the present invention. In block 82, the action desired by the user is determined. If the user desires to reply to a posted topic or a front message, then in block 84 a determination is made as to whether the user is a member of the forum in which the message is posted. If the user is not a member of the forum then in block 86, an error message may be displayed and the process terminates. Otherwise, in block 88, a determination is made as to whether the topic has been closed. In an exemplary embodiment, a topic is considered closed if the value of the message status field of the record for the topic in topics table 23 (FIG. 2) is CLOSED. Preferably, a user is not allowed to post a reply to a topic that has been closed. As such, if the topic has been closed then in block 86, an error message may be displayed and the process terminates.

If the topic has not been closed, then in block 90 (FIG. 5A), a user-interface for posting a reply is displayed. If desired, the user-interface may be a graphical user-interface. An exemplary user-interface 180 for posting a reply is shown in FIG. 7D. As shown in FIG. 7D, the user may input one or more of the following information: a reply body, a message status, a driver for the topic, and/or the like. While replying to the topic, in addition to other things, the user may reassign the topic to someone else by specifying a new driver. If desired, the user may close the topic by changing the message status to CLOSED.

In block 91, input from the user is received. In block 92, a determination is made as to whether the username of the user designated as the driver is a valid username. If the username of the driver is not a valid username, then in block 86 an error message may be displayed and the process terminates.

Otherwise in block 94, a determination is made as to whether the status of the posted topic was changed from PENDING, WORKING or FINISHED. If the status of the topic was not changed from PENDING, WORKING or FINISHED, then the process starting at block 96 is executed. Otherwise, in block 98, a determination is made as to whether the user was the driver prior to the user changing the status of the topic. If the user was not the driver prior to the user changing the status, then in block 86, an error message may be displayed and the process terminates, because preferably only the driver of a topic may change the status of the topic. If the user was the driver of the topic prior to changing the status, then the process starting at block 96 is executed. In block 96, the reply is posted and the process terminates.

Posting a reply comprises creating a record for the reply, adding the record to replies table 25 (FIG. 2) and also updating the record for the topic in topics table 23 as appropriate or more of the following fields in topics table 23 may be updated: the driver ID field assigned the ID of the new driver depending on the change, if any, made by the user; the message status ID field is assigned an ID corresponding to the new status of the message depending on the change, if any, made by the user; and the message type ID field is assigned an ID corresponding to the new message type depending on the change, if any, made by the user.

In the new record in replies table 25, the forum ID field is assigned the ID of the forum in which the reply is posted; the topic ID field is assigned the ID of the topic to which the reply is posted; and the reply author ID field is assigned the ID of the user posting the reply new topic. Other fields in the new record may be assigned appropriate values.

If in block 82 (FIG. 5A), it is determined that the user desires to edit a posted reply to a topic, then in block 100 a determination is made as to whether the user is the author of the posted reply that he desires to edit. Preferably, only the author of a reply may edit it. In examplary embodiment, this determination may be made by comparing the reply author ID of the posted reply in replies table 25 (FIG. 2) with the ID of the user. If the user is not the author of the posted reply then in block 102 (FIG. 5A), an error message may be displayed and the process terminates. Otherwise, in block 104, a determination is made as to whether any replies have been posted since the reply to be edited was posted. If replies have been posted after the reply to be edited was posted, then in block 102, an error message may be displayed and the process terminates. Otherwise, in block 106, a determination is made as to whether the topic has been closed. Preferably, a user is not allowed to edit a reply to a topic that has been closed. As such, if the topic has been closed then in block 102, an error message may be displayed and the process terminates.

If the topic has not been closed, then in block 108, a user-interface for editing a posted reply is displayed. If desired, the user-interface may be a graphical user-interface. An exemplary user-interface for editing a posted reply is similar to the user-interface for posting a reply as discussed with reference to block 90. The user may edit one or more of the following information: a reply body, a message status, a driver for the topic, and/or the like. While editing a posted reply, in addition to other things, the user may edit the body of the posted reply, or reassign the topic to someone else by specifying a new driver. If desired, the user may close the topic by changing the message status to CLOSED.

In block 109, input from the user is received. In block 110, a determination is made as to whether the username of the user designated as the driver is a valid username. If the username of the driver is not a valid username, then in block 102 an error message may be displayed and the process terminates.

Otherwise in block 112, a determination is made as to whether the status of the topic was changed from PENDING, WORKING or FINISHED. If the status of the topic was not changed from PENDING, WORKING or FINISHED, then the process starting at block 114 is executed. Otherwise, in block 116, a determination is made as to whether the user was the driver prior to the user changing the status of the topic. If the user was not the driver prior to the user changing the status, then in block 102, an error message may be displayed and the process terminates, because preferably only the driver of a topic may change the status of the topic. If the user was the driver of the topic prior to changing the status, then the process starting at block 114 is executed. In block 114, the updated reply is posted and the process terminates. Updating the reply comprises updating the record for the posted reply in replies table 25 (FIG. 2) and also updating the record for the topic in topics table 23 as appropriate.

One or more of the following fields in topics table 23 may be updated: the driver ID field is assigned the ID of the new driver depending on the change, if any, made by the user; the message status ID field is assigned an ID corresponding to the new status of the message depending on the change, if any, made by the user; and the message type ID field is assigned an ID corresponding to the new message type depending on the change, if any, made by the user.

In replies table 25, the reply body field is updated to contain the updated text of the reply and the reply date field is updated to reflect the date and time the edited reply was posted. Other fields in the record may be assigned appropriate values.

If in block 82 (FIG. 5B), it is determined that the user desires to edit an initial posting, then in block 120 a determination is made as to whether the user is the author of the initial posting that he desires to edit. Preferably, only the author of an initial posting may edit it. In an exemplary embodiment, this determination may be made by comparing the author ID of the initial posting in topics table 23 (FIG. 2) with the ID of the user. If the user is not the author of the initial posting then in block 122 (FIG. 5B), an error message may be displayed and the process terminates. Otherwise, in block 124, a determination is made as to whether any replies to the initial posting have been posted. If replies have been posted, then in block 122, an error message may be displayed and the process terminates. Otherwise, in block 126, a determination is made as to whether the topic has been closed. Preferably, a user is not allowed to edit an initial posting for a topic that has been closed. As such, if the topic has been closed then in block 122, an error message may be displayed and the process terminates.

If the topic has not been closed, then in block 128, a user-interface for editing the posting is displayed. If desired, the user-interface may be a graphical user-interface. An exemplary user-interface for editing a posting is similar to the user-interface for initially posting a topic. The user may edit one or more of the following information: a topic subject, a topic body, a message type, a message status, a driver for the topic, and/or the like.

In block 130, input from the user is received. In block 132, a determination is made as to whether the username of the user designated as the driver is a valid username. If the username of the driver is not a valid username, then in block 122 an error message may be displayed and the process terminates.

Otherwise in block 134, a determination is made as to whether the status of the topic was changed from PENDING, WORKING or FINISHED. If the status of the topic was not changed from PENDING, WORKING or FINISHED, then the process starting at block 136 is executed. Otherwise, in block 138, a determination is made as to whether the user was the driver of the topic prior to the user changing the status of the topic. If the user was not the driver prior to the user changing the status, then in block 122, an error message may be displayed and the process terminates, because preferably only the driver of a topic may change the status of the topic. If the user was the driver of the topic prior to changing the status, then the process starting at block 136 is executed. In block 136, the initial posting is updated and the process terminates. Updating the initial posting comprises updating the record for the posting in topics table 23 (FIG. 2) as appropriate.

One or more of the following fields in topics table 23 may be updated: the driver ID field is assigned the ID of the new driver depending on the change, if any, made by the user; the message status ID field is assigned an ID corresponding to the new status of the message depending on the change, if any, made by the user; the message type ID field is assigned an ID corresponding to the new message type depending on the change, if any, made by the user; the topic body field is updated to contain the updated text of the posting; the topic subject field is updated to contain the updated subject for the topic; and the topic date field is updated to reflect the date and time the topic was posted. Other fields in the record may be assigned appropriate values.

FIG. 6 is a flowchart of a method 150 for displaying a front message and its associated replies. In block 152, the message type of the front message to be displayed, the status of the front message and information about the driver of the front message is determined. This information may be determined from the appropriate record in topics table 23 (FIG. 2). In block 154 (FIG. 6), replies to the front message are retrieved. The replies may be determined by searching replies table 25 (FIG. 2) for records whose topic ID matches the ID of the front message. In block 156 (FIG. 6), the replies are sorted by date. In block 158, information about the front message is displayed on a user-interface. If desired, the user-interface may be a graphical user-interface. FIG. 7E is a screen shot of an exemplary user-interface displaying a front message and its associated replies. In the user-interface of FIG. 7E, the ID of the front message, its status, its type and driver information are displayed in a table, such as table 164. In block 160, the text of the front message, the username of the author, and the date the front message was posted is displayed. In block 162, the replies to the front message are displayed in a predefined order, for example a chronological order. In an exemplary embodiment, for each reply, the text of the reply, the username of the author, and the date of the reply are displayed.

FIG. 7F is a screen shot of an exemplary user-interface displaying all unclosed front messages. In order to display all unclosed front messages, the user may select an icon or link 166. In response, the front messages whose message status is other than CLOSED are retrieved from topics table 23 (FIG. 2). The retrieved front messages are displayed, for example as shown in table 168 of FIG. 7F. In the illustrated embodiment, table 168 includes the topic ID, the message type, the message status, the username of the user to whom the front message is assigned, topic subject and the date the front message was last updated. If desired, table 168 may display a fewer or greater number of fields. A centralized location for viewing all open front messages is provided which makes it easier to track messages assigned to different members of the group. Because the messages are public, members would be more inclined to handle the messages faster thereby increasing the productivity of the group.

FIG. 7G is a screen shot of an exemplary user-interface displaying all unclosed front messages assigned to a selected user. In order to display all unclosed front messages assigned to a selected user, the user may select a link, for example link 170 for that user from table 168 of FIG. 7F. In response, the front messages whose message status is other than CLOSED and whose driver ID matches the member ID of the selected user are retrieved from topics table 23 (FIG. 2). The retrieved front messages are displayed, for example as shown in table 172 of FIG. 7G. In the illustrated embodiment, table 172 includes the topic ID of the message, the message type, the message status, the topic subject and the date the topic was last updated. If desired, table 172 may display a fewer or greater number of fields.

FIG. 7H is a screen shot of an exemplary embodiment user-interface displaying all unclosed front messages originated by the user. In order to display all unclosed front messages originated by the user, the user may select a link, for example link 176 (FIG. 7F). In response, the front message whose message status is other than CLOSED and whose driver ID matches the member ID of the user are retrieved from topics table 23 (FIG. 2). The retrieved front messages are displayed, for example as shown in table 178 of FIG. 7H. In the illustrated embodiment, table 178 includes the topic ID of the message, the message type, the message status, the username of the user to whom the front message is assigned, the topic subject and the date the topic was last updated. If desired, table 178 may display a fewer or greater number of fields.

The present invention may be implemented in software, hardware, or a combination of both software and hardware. If desired, the different functions discussed herein may be performed in any order and/or concurrently with each other. Furthermore, if desired, one or more of the above described functions may be optional or may be combined without departing from the scope of the present invention.

A technical advantage of an exemplary embodiment of the present invention is that a user may view all unclosed messages. Another technical advantage of an examplary embodiment of the present invention is that a user may view all unclosed messages assigned to a selected user. Another technical advantage of an exemplary embodiment of the present invention is that a user may view all unclosed messages originated by him/her.

A communication infrastructure for community building allows one of more of the following functions to be implemented: Front Messages, Geographic Shopping, Recent Viewing, Latest News, Local Talk, Browser Notes, Casual Messages, Commitment Messages, Integrity Check, Recent Visitors, Diary, Front Requests, User Snapshot, Podium Messaging, Neighborhood Search, Mobile Engagement, etc.

Geographic Shopping:

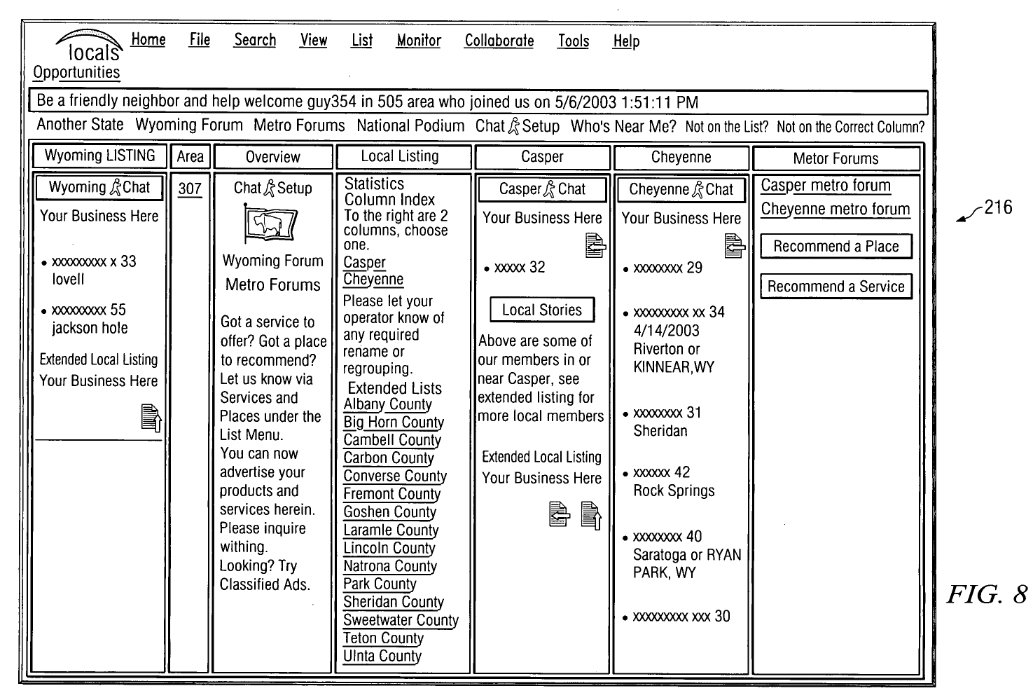

FIG. 8 is a screen shot of an exemplary embodiment user-interface 216 for geographic shopping. Geographic shopping is the making of a selection based on relative geographical location in consideration against other involved attributes. When you decide to drive the distance for a smaller price on the same car, you are doing geographic shopping. An enterprise, in another example, may be shopping for several vendors, let's say the most active service providers, near their offices around the country. This would traditionally take hours, days or even weeks. In accordance with an embodiment of the present invention, it can be done two clicks for each office location.

With respect to Geographic Shopping, each server complex is called a kingdom. The ultimate financier for this Kingdom is called the Kingdom Owner. A universally unique Kingdom ID identifies each kingdom. This is attached to every piece of data that is passed from one to another kingdom.

A kingdom is divided into communities. A community is under the management of a Community Operator. Public data such as zip code and area code databases is shared across communities. Each person registered with a kingdom is called a Kingdom Account Holder. This person must be a member of at least one community. A kingdom account holder (KAH) may choose to be a member of each and every community there is in the kingdom. The user may choose to have a different member name in each community.

Each community may be accessed via a unique URL, referred herein as a domain name. A community must have at least one domain name. A community operator may offer a set of different domain names for access to various sections in the community by its members. While using the system under the name of a community, the user may not see data that applies only to other communities.

Kingdom, community and domain respectively determine financial, demographic and technical limits of every data object. The concepts of sphere, layer and region are used to handle cultural, physical and political limits of the data. In accordance with an embodiment of the present invention, a data object may represent, for example, a car, an idea or a person. Attached to each piece of user data is a list of spheres in which the data may be made visible. Likewise, attached to each piece of user data is a list of layers in which the data may be made visible. Furthermore, attached to each piece of user data is a set of political properties, which include zip code, the nearest city, the nearest apartment, etc.

A community operator may be provided a user interface to determine regional boundaries for their data. In one community, each state is divided into five regular regions: Northern, Southern, Eastern, Western and Central. In another community, each state is divided into cities or counties. Even within the same community, the operator may choose to use a different set of political boundaries for each cultural sphere. For the Education Sphere, school district boundaries are used. For the Nightlife Sphere, city boundaries are used. County boundaries are used for the Business Sphere. A community operator may deal with just one cultural sphere. Each sphere in every community is given its own set of regional boundaries as selected or defined by the community operator.

A building, for example, may be declared by an operator to be visible in Business Sphere but not visible in Nightlife Sphere. The sphere in which that building is in determines its visibility at display time. The same building may be visible on the Geo-Facility Layer but not on the Road System Layer. This building is seen as part of the Northern Region of a state in one community. In another community yet in the same state, this building of the same geographic location is seen as part of a region of a different name and with a different set of regional boundaries.

When the system receives a request to do data search for a geographic shopping experience, the system includes only the data applicable to the currently selected cultural sphere and layers. The system then displays the data in a table. Each data column represents a region as defined by the currently selected sphere and currently selected layers applicable to that sphere. When there is no data found for a region, that region is not visible. When there is data found, a column is displayed to show all the records found applicable to that region.

Preferably, only one sphere may be selected at any time. The user can only work with just one sphere and with just one community at any given time. The user cannot switch from one to another community without logging in from scratch again but the user may switch from one to another sphere within that community. The user may turn on or off one or more data layers applicable to a sphere in the community.

The community operator can set the maximum number of records the system can display per search and per region. In this way, the user is not overwhelmed by data coming from a major population center. For example, in Illinois, given a maximum of 500 records per search, profile search in a demographic application may turn up 495 records under Chicago and 5 records for rural regions. This may not be what the user wants. If the operator set the limit for each region to be, say, 24, then the column for Chicago can only have 24 records and the system is forced to cough up more records in rural areas. The web page, State Preview, for Illinois in the prototype demonstrates this when the user searches for the newest members in that state. For Texas, in the prototype, there are 60 different regions but columns for rural regions without records found are not shown keeping distraction to the minimum.

A user may also search for other users by apartment, school, highway crossings, and/or the like. This gives the user the ability to search for real and local neighbors. This is much better than using zip code or city as a criteria because a zip code or a city may cover a substantial number of neighborhoods. Additional fields, such as a highway field for storing information on a highway close to the user, a crossing field for storing information about a highway crossing close to the user, an apartment field for storing information about a neighborhood close to the user, and a school field for storing information about a school close to the user, may be added to members table 15 and the search performed on the respective fields as desirable. The relevant information to be added to the fields is preferably provided by the user, for example during sign-up.

Recent Viewing:

Traditionally, in a group setting, not all members of the group have the same information about the activities of the members of the group. One or more members, typically group leaders, have more information than the rest of the group.

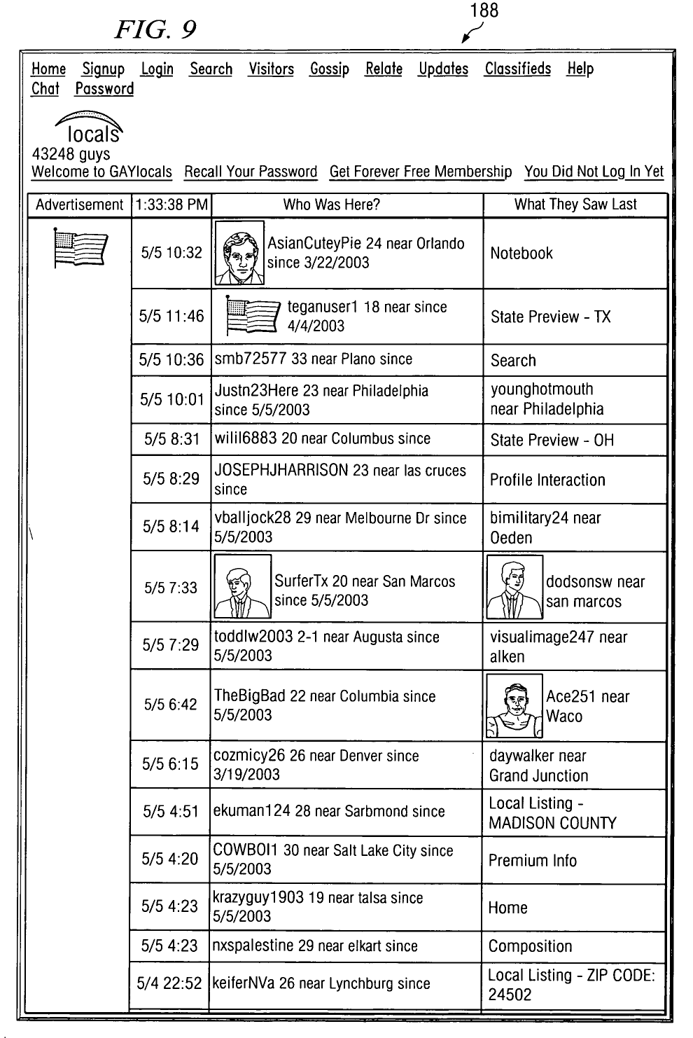

FIG. 9 is a screen shot of an exemplary embodiment user-interface 188 for displaying recent viewing information. In an exemplary embodiment, information about members of the group may be made available to the other members of the group without regard to the status of the members. Information on the most recent activities of the members may be provided in an easy to use manner. Also, if desired, demographic information for the members may also be provided.

An advantage of the exemplary embodiment of the present invention is that it increases the sense of community within the group by providing information on the activities and/or interests of the members of the group to the other members. By being aware of the activities and/or interests of the members of the group, the source of a bottleneck may be identified and appropriate assistance provided to the source of the bottleneck.

In the illustrated embodiment, a user, for example a member of the group, may access a web site and simply select a link, for example the “Visitors” link in the illustrated embodiment. In response to the user selecting the link, information on the members of the group is provided to the user in an appropriate form, such as a table. The information is preferably provided to the user via a user interface, such as a web browser. In the illustrated embodiment, the user accesses a web site of a web-based community to access information on the activities of the members of the community. In the illustrated embodiment, the information provided comprises date and time of the last activity of the member, the identifier of the member, his age, location, the date on which the particular member became a member of the group, and/or recent viewing activity of the member. The date on which a particular member became a member of the group may determine the status or seniority of the member. A color coding scheme may be used to distinguish between the status or seniority of the different members.

If desired, the results may be provided in a user-selectable format. In the illustrated embodiment, the information is provided in chronological order in a table form with the member with the most recent activity being displayed first. Preferably, each row of the table includes information on a single member of the group. However, if desired, more than one row may be used to display information on any member of the group. Although in the illustrated embodiment, only the most recent viewing information is provided, the invention is not so limited. If desired, the number of activities displayed for a member may be user-defined.

In an exemplary embodiment, the activities of each member of the group are tracked and in response to receiving a request for the most recent information, a process may be executed, preferably in software, to organize, arrange and/or provide the information in the user-selected format.

The concepts of the exemplary embodiment of the present invention may be used in any context where a group of individuals are involved in an activity. The group of individuals may be a temporary collection of individuals, such as at a resort, a convention, or a meeting, or a more permanent collection of individuals, such as individuals working in the same department of a company. An immediate sense of community may be provided to the members of the group by providing them information on the other members of the group.

Information on merchandise being viewed by potential buyers may be provided to the seller of such merchandise. Moreover, potential buyers of a merchandise may communicate with each other if they know that the other potential buyers have viewed the product recently.

If desired, the information displayed may be sorted or grouped by what has been viewed. For example, if multiple buyers view the same merchandise, then the information may be listed by merchandise.

If desired, in the exemplary screen shot of FIG. 9, the column “WHAT THEY SAW LAST” may display links to topics, profile or any other type of data that was last viewed or handled by the users. The links may be used to traverse to the same “place” so the user can also have the same web experience as being experienced by the other users. Furthermore, if desired, a predefined number of the latest activities of the users may be displayed. Thus, easy access to the data being handled by the users may be provided to the other users.

Sharing of Information (Latest News):

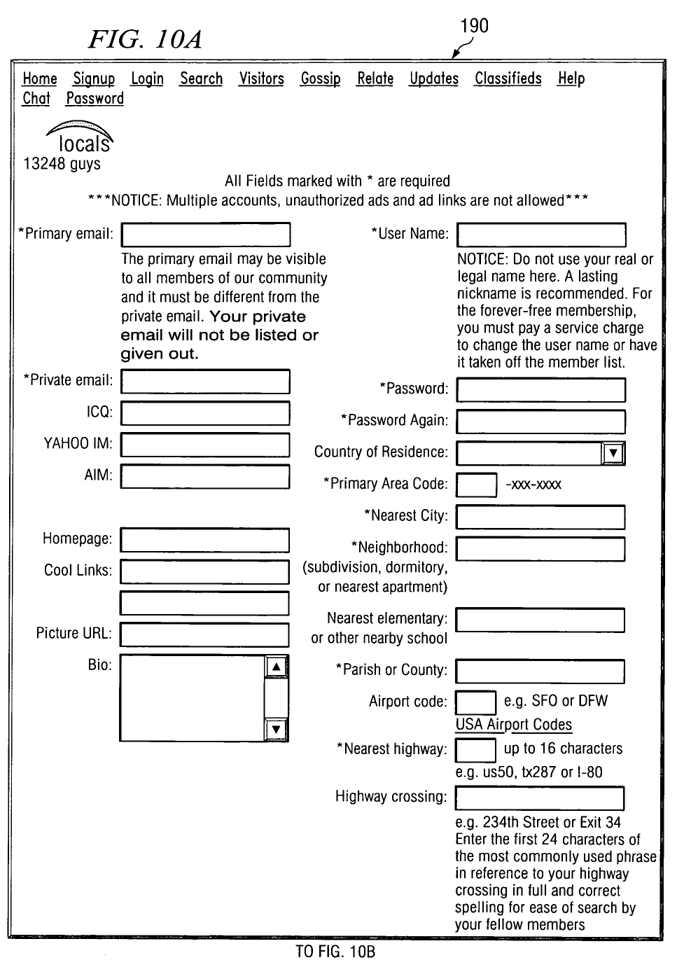

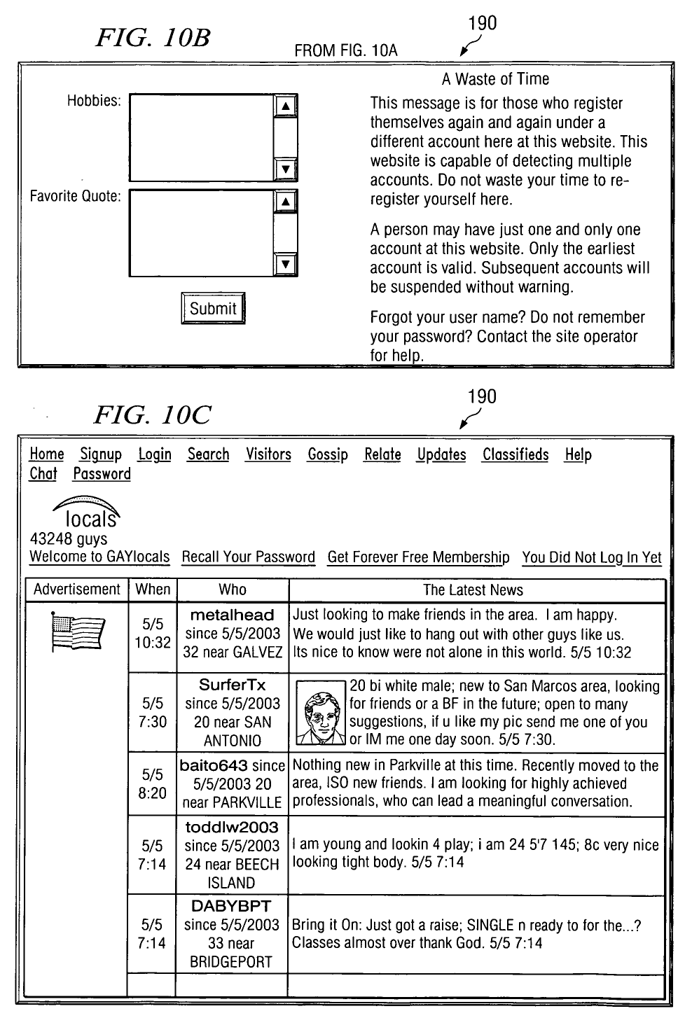

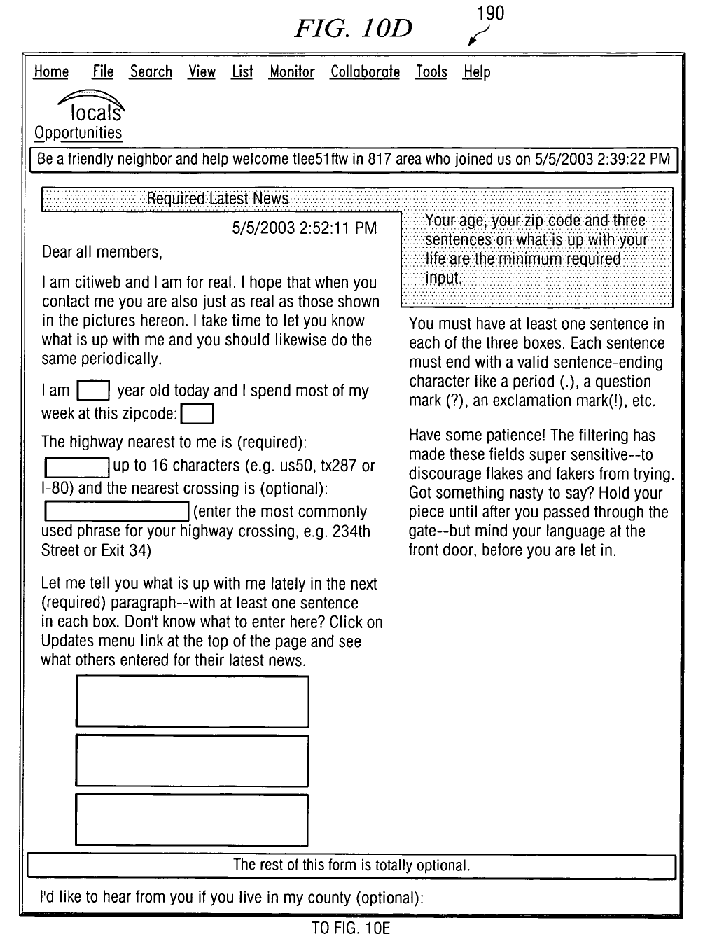

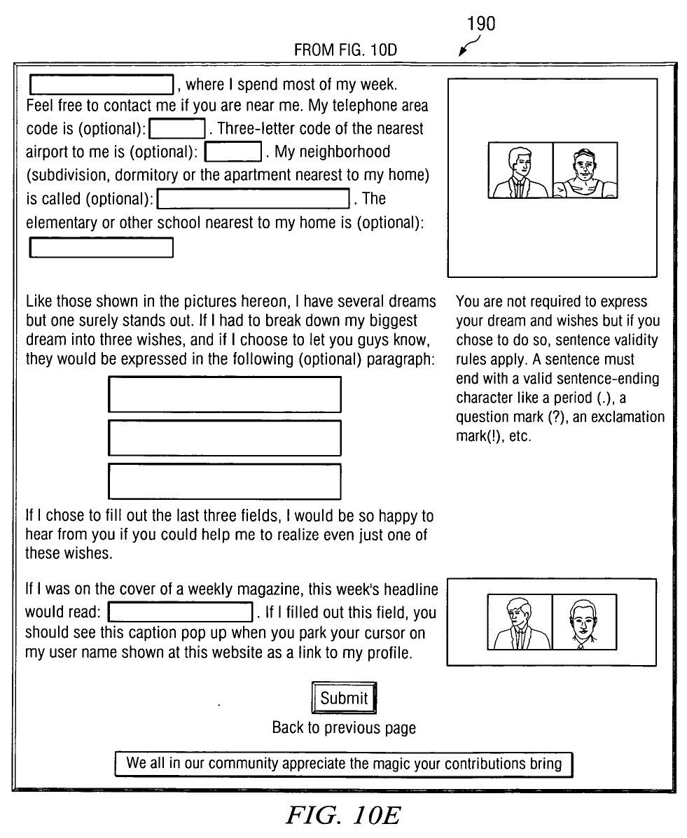

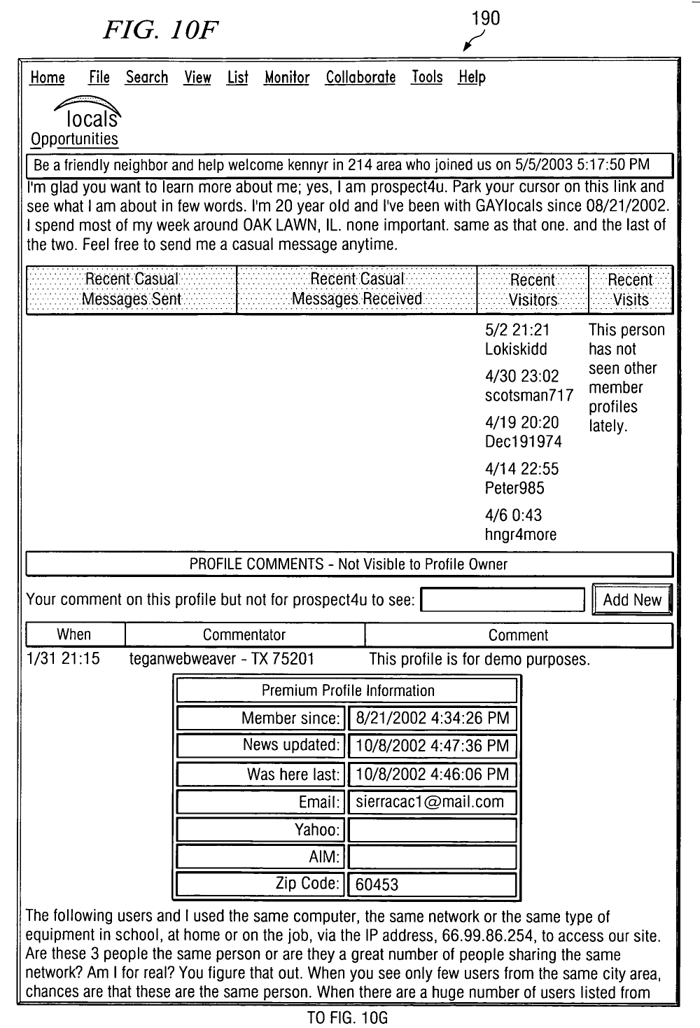

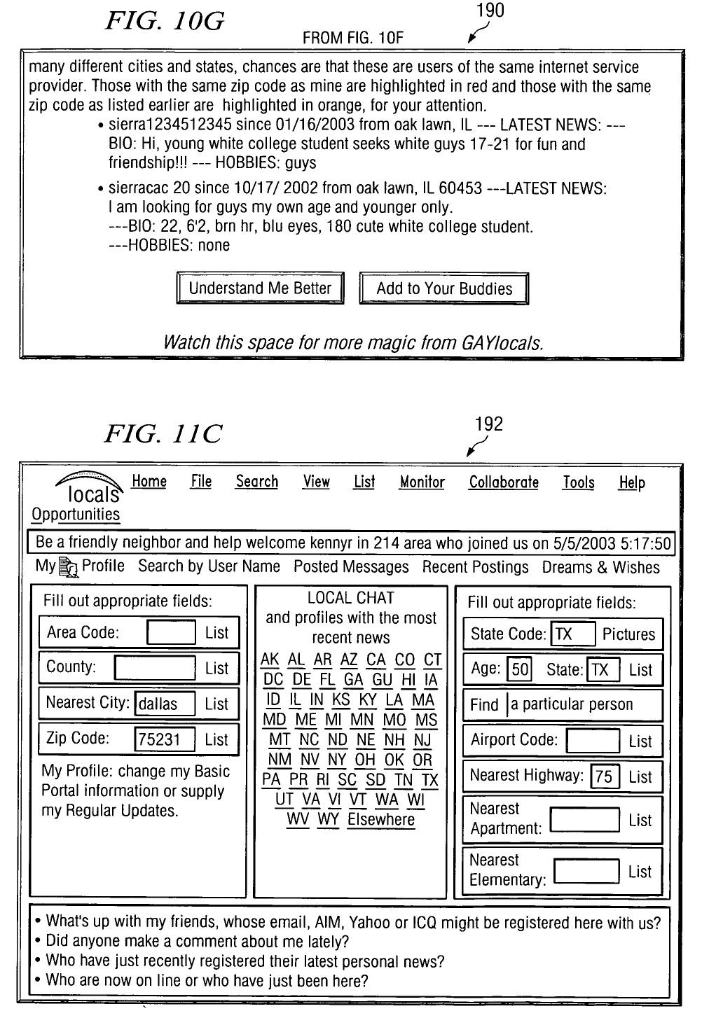

FIGS. 10A-10G are screen shots of an exemplary embodiment user-interface 190 for sharing of information. In an exemplary embodiment of the present invention, members of a group share information on their recent activities. The information shared by the members may be provided to the rest of the group. Preferably, each member of the group is required to share information on their activities periodically. If a member fails to share information on his or her activities, then their membership in the group is terminated. A member whose membership has been terminated may rejoin the group. However, the seniority of the member within the group is not maintained. Also, information previously provided by the member may be removed upon termination of membership and as such the member may be required to start over. The shared information may be displayed to the other members of the group.

By terminating membership of the members who fail to share information with other members of the group, the sense of community within the group may be increased as each member is forced to update other members of the group on his/her recent activities.

The information shared by members of the group may be an advertisement, project updates, marketing/sales leads, latest business transactions, and/or the like. Thus, by sharing information with other members of the group, the members may update each other on the latest activities in their lives.

The concepts of the present invention may be used to advantage by a project team to ensure that deadlines are met, a family to keep abreast of important activities in each other's lives, a sales team to share leads with each other, by members of a web-based community to reveal information about their lives to other members of the community, and/or the like.

In the embodiment of a web based community as illustrated in FIGS. 10A and 10B, when a new member signs-up to become a member of a web-based community, the new member is encouraged to provide information on the latest activities in his/her life. If desired, the new member may be encouraged to provide other information also, such as age of the member, the location of the member, and/or the like. When the user's profile is accessed, his latest information may be displayed (FIGS. 10F and 10G).

In the illustrated embodiment, in order to access information on other members on the group, a user, for example a member of the group, may access a web site and simply select a link, for example the “Updates” link in the illustrated embodiment. In response to the user selecting the link, information on the latest activities of the members of the group is provided to the user in an appropriate form, such as a table (FIG. 10C). The information is preferably provided to the user via a user interface, such as a web browser. In the illustrated embodiment, the user is a member of a web community and accesses a web site for that community to either share his information or to access information on other members of the community. In the illustrated embodiment, the information provided comprises the date and time the member provided the information, the member's demographic information, the actual information provided by the member, and/or the like. If desired, information provided by the member prior to the last update may also be displayed.

If desired, the information may be provided in a user-selectable format. In the illustrated embodiment, the information is provided in chronological order with the member who updated his information most recently being displayed first.

In an exemplary embodiment, each member of the group is required to provide updated information periodically (FIGS. 10D and 10E) and in response to receiving a request for the most recent information, a process may be executed, preferably in software, to organize and arrange the information provided by the members. The concepts of the exemplary embodiment of the present invention may be used in any context where a group of individuals are involved in an activity.

Local Talk:

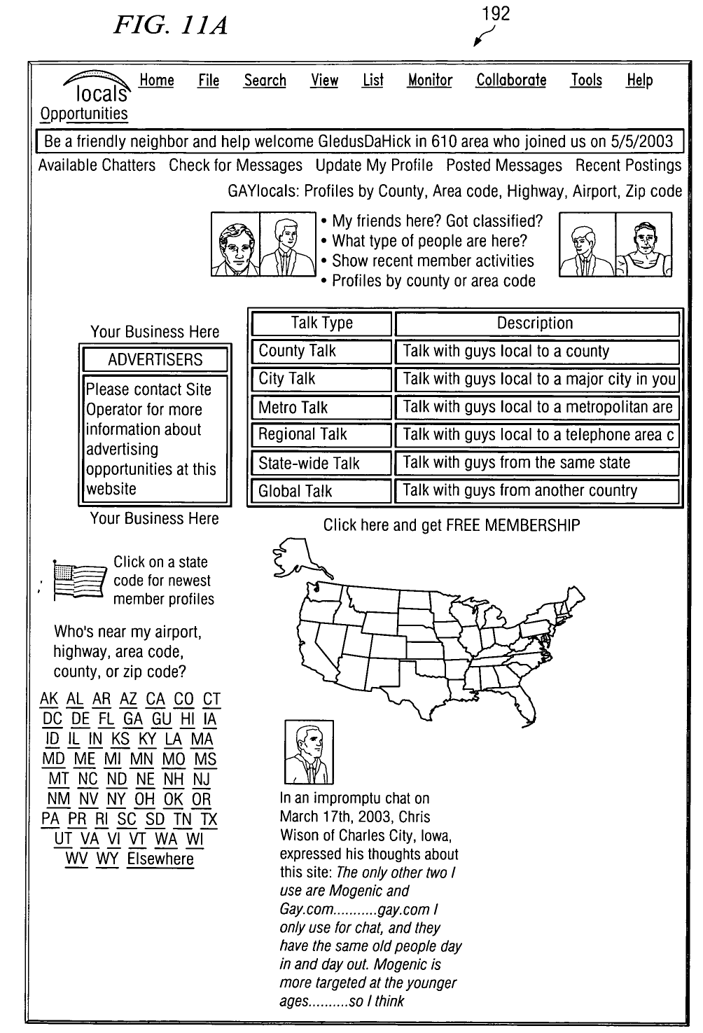

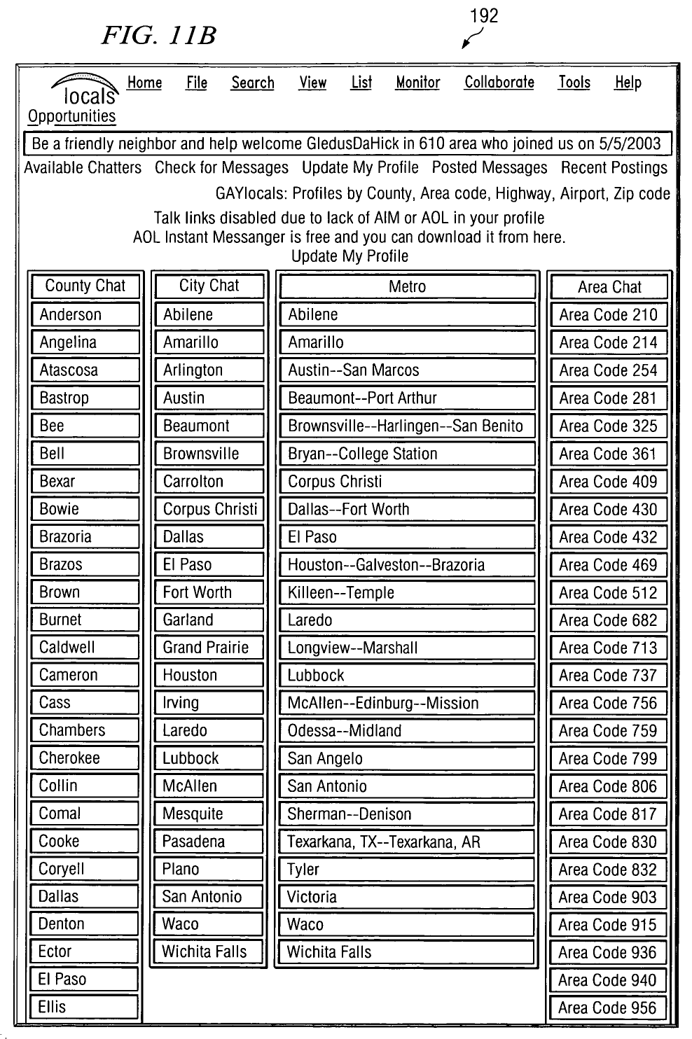

FIGS. 11A-11C are screen shots of an exemplary embodiment user-interface 192 for local talk. Local talk is a tool that provides the users a one-click access to a “village” or community of people on any one of several geographical scopes via the global computer network. The geographical scope can be on a neighborhood, city, county, metropolitan area, regional, state, and global scale. However, because of Local Talk, users may interact and communicate on a more personal level independent of the geographical distance between them. Local flavor is achieved on a global scale. The functions of chat rooms, forums and location are combined to give rise to this new communication paradigm.

When a new user registers at a website that features Local Talk, he is asked to supply data for a number of data fields, such as a user name or identifier, a password, age, and state and zip code of his residence. Other types of data may also be requested. The data associated with each user is stored as a user's profile in a data record, for example. As illustrated in FIG. 11A, as a user logs in, he is presented with a list by geographical scope, such as county talk, city talk, metro talk, regional talk, statewide talk, and global talk. Further, a list of states may also be listed. The user may, using one-click, access and communicate with community users whose geographical scope fits his one-click selection. Upon selecting a particular state, for example, a screen (FIG. 11B) is displayed where the user community is listed by regional category to permit quick and easy browsing. Preferably, other user criteria are used to further sharpen or narrow the scope of the community user listing, such as listing those community users whose age are proximate the current user's age. If desired, other user criteria may be used to perform the initial search as illustrated in FIG. 11C.

The community users listing may also be by forum, such as grouping by age, and by any of the geographical groupings. As a further example, the current user may ask for a list of Neighbors, who may be defined as community users who have similar interests or have posted messages in a particular forum. The current user may choose to chat with a particular community user or post a message to a forum of community users.

The community user listings provide the user name, which is a hypertext link, a date that the community user has been registered at the website, and a location designation. Further, community user's data may be color-coded to provide further visual cue about the user's level of activity on the website.

To provide these geographically or forum-focused community user listings, the community user profile records are scanned to select those community users who fits the selection criteria. For example, the zip code field or state field may be used to determine the geographical location of the community users and displayed. The age field may be another criteria searched.

Browser Notes:

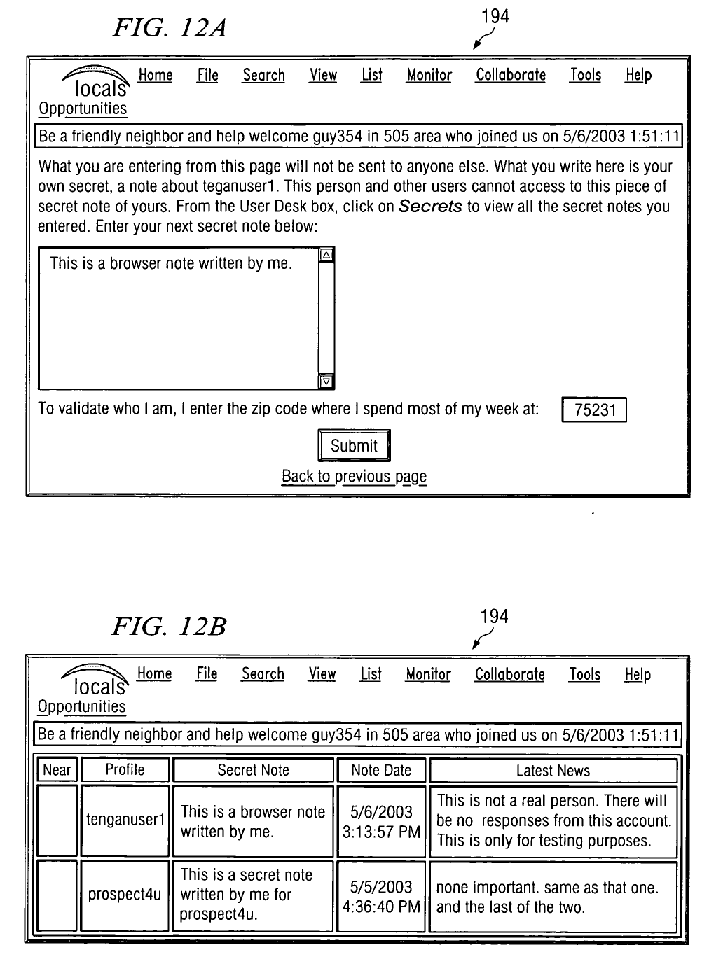

FIGS. 12A and 12B are screen shots of an exemplary embodiment user-interface 194 for browser notes. Browser notes is a feature that allows a logged-on current user to enter notes about a particular community user, which is accessible only to the current user (FIG. 12A). The current user may, upon a single click, access all of his browser notes about other community users (FIG. 12B). Each browser note is associated with a profile of a particular community user, and may contain a hypertext link to that user's profile.

For each user, a table is constructed in which each entry includes the author's identification (user name), the subject profile identifier, and the note itself. These browser notes are not accessible by anyone other than the author of the notes, and the system administrators. This feature allows the users to record personal notes about other community users in a very handy and easily accessible manner.

The same concept may be used for storing or remembering a user's private thought on any web page such that whenever the user arrives at that same web page, the previously noted private thought is displayed to remind the user of what that user thought of that web page.

Casual Messages:

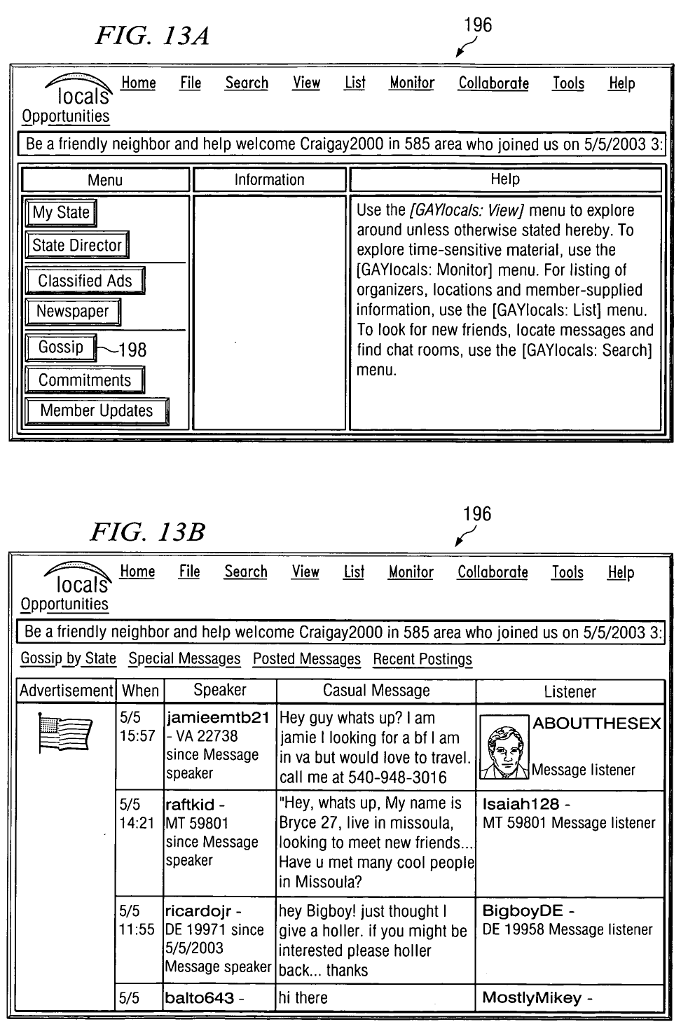

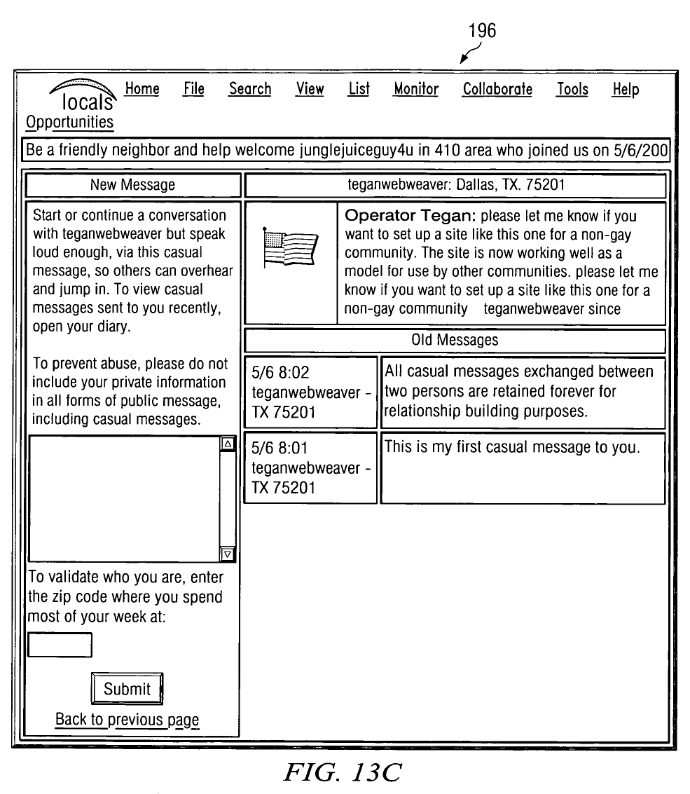

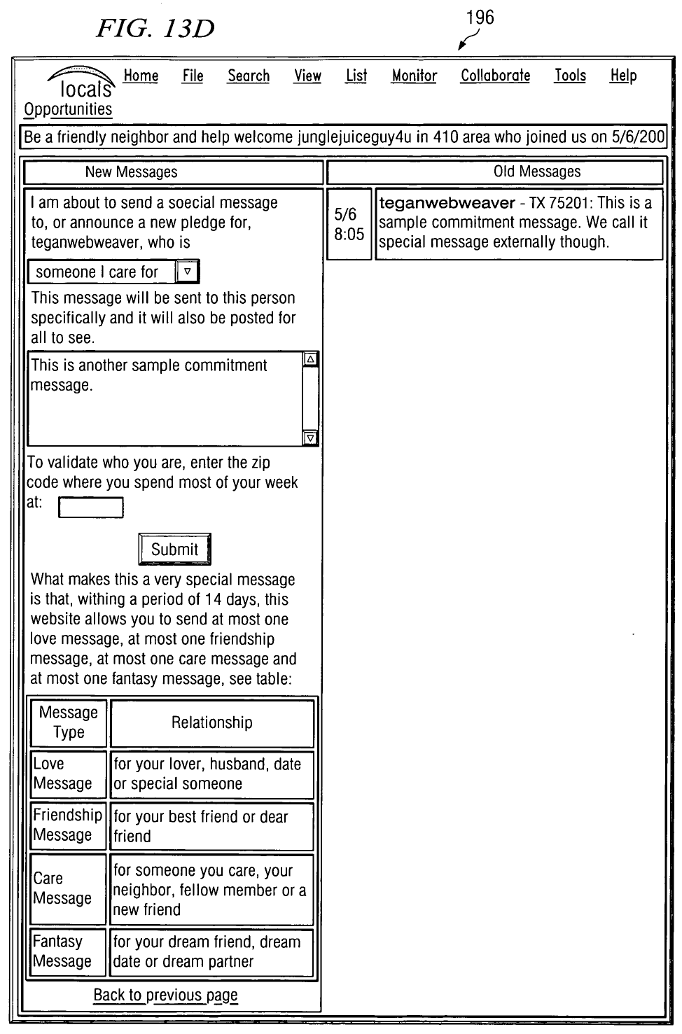

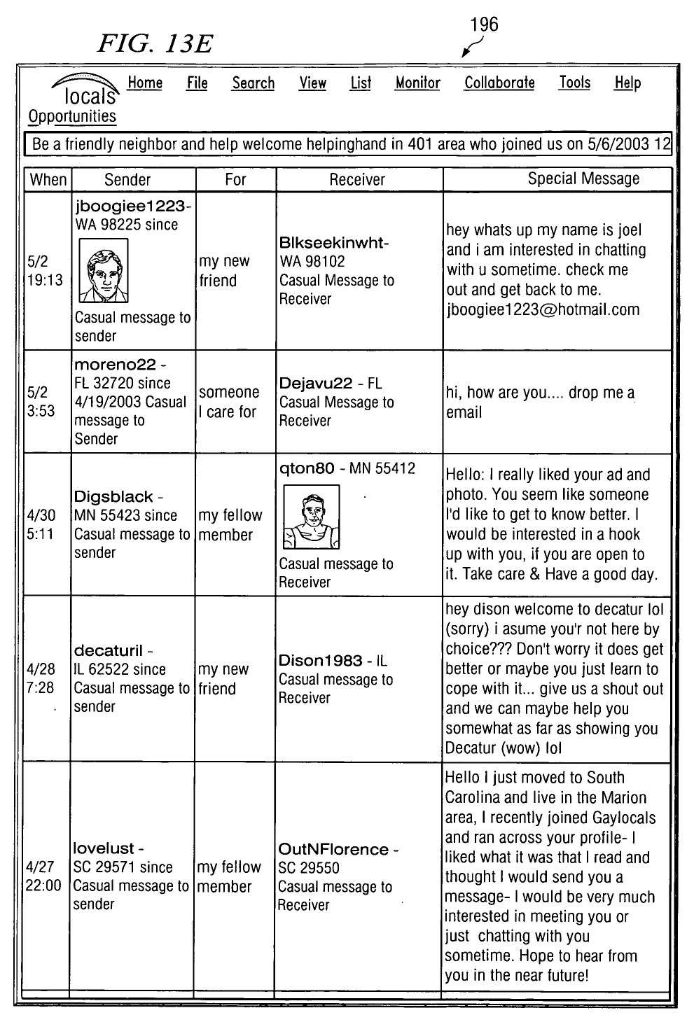

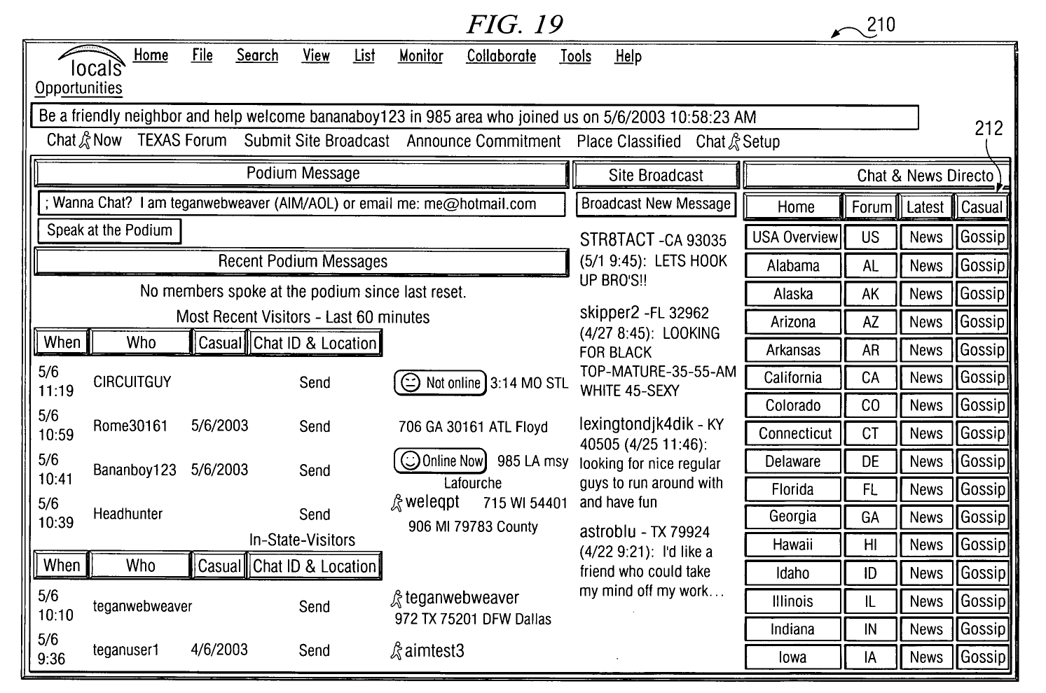

FIGS. 13A-13C are screen shots of an exemplary embodiment user-interface 196 for casual messages. Casual messages is communicated or targeted, by one user, to a particular community user. However, unlike browser notes, Casual Messages can be “overheard” by other community users. Unlike conventional emails, other community users can view Casual Messages. Unlike conventional chat rooms, a user does not have to be online for another user to post a casual message to him. If preferred, a user may enable email or front message notification to him to notify him that a casual message has been sent to him. A user may access casual messages sent to him by clicking on the “Notebook” link. Other community users may listen in on the casual messages by clicking on a “gossip” link 198 as shown in FIG. 13A or a gossip link 212 as shown in FIG. 19. When the user clicks on “gossip” link 212, preferably only casual messages from the selected geographical region are shown. The displayed table (FIG. 13B) lists the dates of the casual messages, the sender identities, the receiver identities and the casual messages. FIG. 13C is a screen shot of an exemplary embodiment user-interface 196 for sending a casual message. Preferably, all casual messages exchanged between the sender and the recipient of a casual message are displayed. Casual messages are another way that the users in the community can communicate with one another. Casual messages are preferably retained for the life of the relationship between the sender and the receiver of the casual message or for such time as the sender or receiver desire.

FIGS. 13D-13E are screen shots of an exemplary embodiment user-interface 196 for commitment messages. A commitment message is a variation of a casual message. In a commitment message, the user also includes a declaration of his relationship with the person to whom the commitment message is directed. A user may access commitment messages sent to him by clicking on the “Notebook” link. Other community users may listen in on the commitment messages by clicking on a “Commitments” link 214 (FIG. 13A). The displayed table (FIG. 13E) lists the dates of the commitment messages, the sender identities, the declared relationship, the receiver identities and the commitment messages. FIG. 13D is a screen shot of an exemplary embodiment user-interface 196 for sending a commitment message.

Understand Me (Integrity Check):

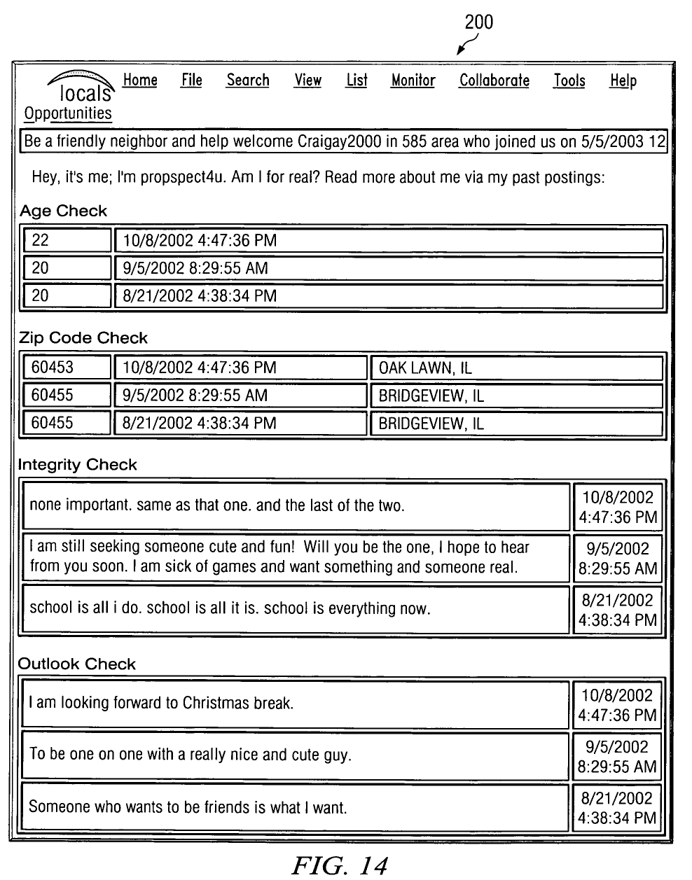

A website or other forum for interaction between users may have a requirement that the registered community users supply certain personal data upon registration as well as at regular time intervals thereafter in order to continuously use the website. For example, a registered user may be required to update the age, zip code, latest news, and outlook every two weeks. FIG. 14 is a screen shot of an exemplary embodiment user-interface 200 for integrity check. Each user's profile includes an “Understand Me Better” link that leads to a historical archive of these periodic updated data. Therefore a chronicle of this personal data of each user is accessible to the community. This data also provides a sort of integrity check on the users because inconsistencies in the data become glaringly visible. For example, if a user stated that his age was 24 on a certain date, but 26 two months later, then this is an inconsistency that becomes clear when the data is presented in a chronicled manner.

Who Saw My Profile:

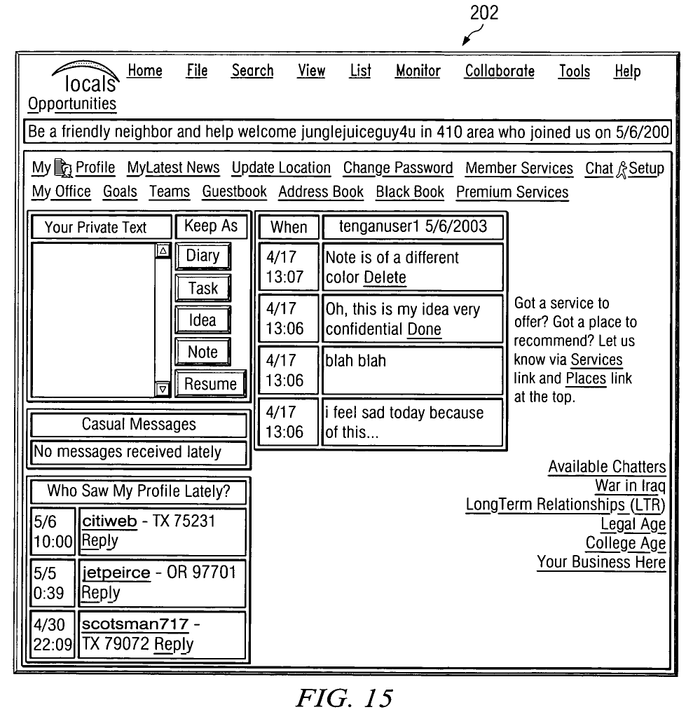

FIG. 15 is a screen shot of an exemplary embodiment user-interface 202 for displaying information on recent visitors of a profile. This feature allows a user to become aware of the identities of community users who have recently accessed or visited the user's own profile. This listing is provided after the logged on user clicks on the “Notebook” link. The date and time of the profile access, as well as the user's identifier, and a limited amount of information, such as his geographical location (zip code and/or state), are displayed in a tabular list.

A table or database of online activities at this website is used to record certain activities of the community users. In the table, the action doer's identifier, the action receiver's identifier (optional depending on the activity), and the action done, are recorded. The recorded activities may include viewing a profile, sending a casual message, sending a door message, taking a browser note, participating in a particular forum, etc. When a user requests the Who Saw My Profile information, this activity table is scanned to select the activity entries that fit the requested criteria. This feature removes the geographical and physical spans between community users.

Diary:

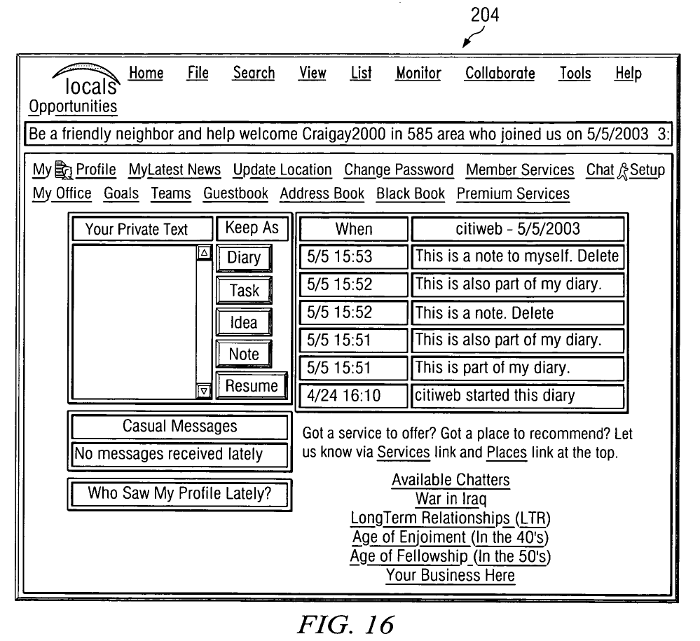

FIG. 16 is a screen shot of an exemplary embodiment user-interface 204 for displaying a diary. Along with the Casual Messages, Browser notes, and Who Saw My Profile entries in the Notebook section of a registered user's private section, other types of entries may also be made. These may include diary entries, task entries, idea entries, and note entries. These are all private entries a user may make. Each type of entry may be linked by hypertext link to a profile of another community user. For example, a diary entry may state, “I met John123 today. He seems to have similar interests and tastes” or a task entry may be “John123—need to get back to him in a couple of weeks after he gets back from vacation.” In the new entry dialog window, a windowpane may display a list of community user identifiers that the current user accessed recently. To link a community user profile to a particular diary, task, note or idea entry, the current user just clicks on the particular user identifier while composing the new entry.

Idea and task entries have a “done” link that enables the user to remove the particular entries. A note entry may have a “delete” link to allow the user to erase the note when it is no longer needed. A diary entry is maintained indefinitely.

Front Requests:

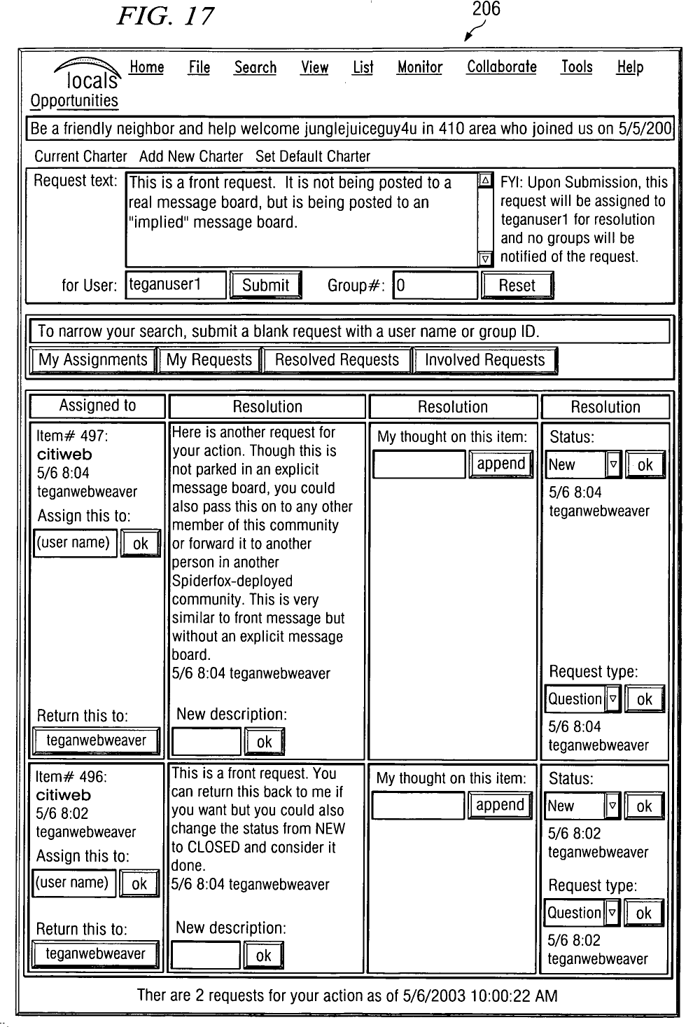

FIG. 17 is a screen shot of an exemplary embodiment user-interface 206 for a front request. A front request is a variation of a front message. However, a front request is not posted in an open forum. Instead, it is parked/posted in an “implied” forum. A front request may be passed from one person to another. A unique identifier, for example a uniform resource locator, may be generated for a front request.

User Snapshot:

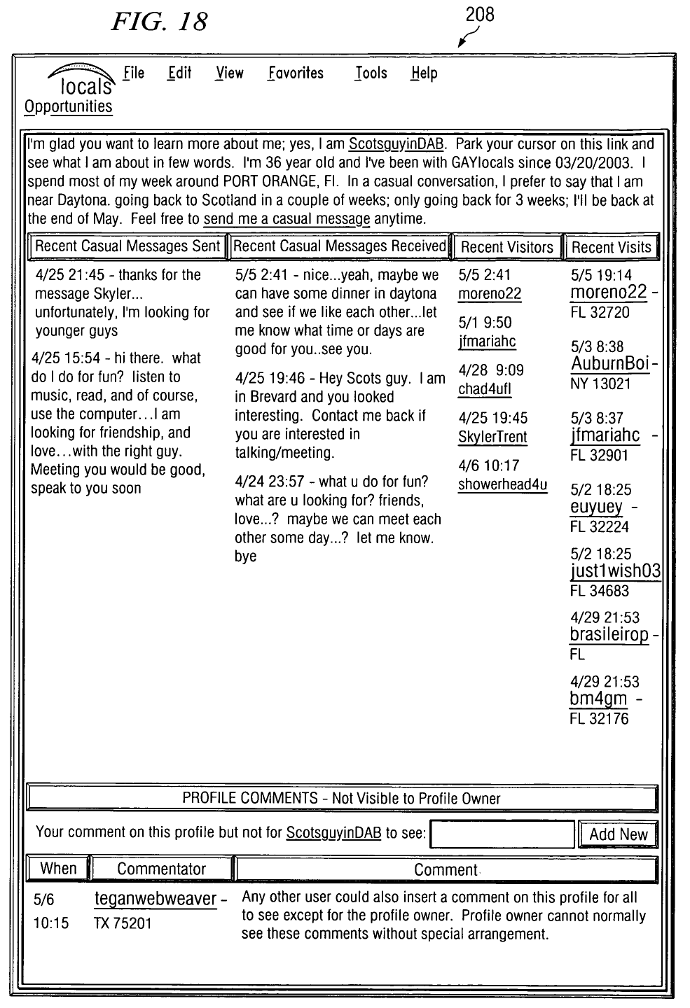

FIG. 18 is a screen shot of an exemplary embodiment user-interface 208 for displaying a user snapshot. In an exemplary embodiment, a snapshot of the user's activities within a predetermined period may be accessed from a user's profile. In FIG. 18, the information displayed comprises, recent casual messages sent by the profile owner, recent casual messages received by the profile owner, recent visitors to view the profile of the profile owner, recent profiles viewed by the profile owner, and/or the like. User-interface 208 provides a summary about the profile owner's activities in an easy to view manner.

If desired, a user may insert comments about the profile owner. Preferably, the comments are not viewable by the profile owner but may be viewed by other users viewing the profile of the profile owner.

Podium Messaging:

FIG. 19 is a screen shot of an exemplary embodiment user-interface 210 for podium messaging. Using podium messaging, a user can post an instant message for other users. The users for whom the instant message is posted may belong to one or more forums. A podium message is an instant message for all users who are currently browsing the website or are currently logged onto a system incorporating podium messaging. A system administrator may choose to allow whether a non-member can view the podium message.

While the podium is not being used, it may issue a default announcement, for example an announcement of the newest member who joined the site last. For example, FIG. 13A illustrates the use of a default announcement “Be a friendly neighbor and help welcome Craigay2000 in 585 area code who joined us recently at . . . ” to encourage other members to welcome a new member. Podium messages may be deleted periodically, for example at the end of the day. A Broadcast message is similar to a podium message. However, the life of a broadcast message is preferably longer than that of a podium message. FIG. 19 illustrates a plurality of broadcast messages in the column “Site Broadcast”.

Mobile Engagement:

Mobile Engagement is similar to Recent Viewing. However, Mobile Engagement applies to users of a mobile device with web capabilities, such as a mobile phone, a PDA, a laptop, a digital camera, etc. The mobile user can search for other members of a community with similar interests and who are in the vicinity of where the mobile device is. The mobile user can view the activities of other users in the vicinity and issue a mobile version of casual massages to them. This facilitates a spontaneous gathering of the users in the location where they happen to be at the time. Instant messages do not work in such a situation because the mobile users cannot always keep their eyes on their mobile devices.

What is claimed is:

1. A method for enabling communications between members of a group, comprising:
enabling a first member of said group to post a public electronic message; and
enabling said first member to assign said message to a second member of said group for handling.

2. The method of claim 1, further comprising enabling said second member to reassign said message to a third member of said group for handling.

3. The method of claim 1, further comprising enabling each member of said group to post electronic replies to said message.

4. The method of claim 3, further comprising enabling each member of said group to edit only those replies posted by said respective member.

5. The method of claim 3, further comprising preventing each member of said group from editing their respective replies subsequent to posting of other replies.

6. The method of claim 3, further comprising preventing said first member from modifying said message subsequent to posting of replies to said message.

7. The method of claim 3, further comprising enabling each member of said group to view said message along with a plurality of said replies to said message in a predefined order.

8. The method of claim 7, wherein said predefined order is a chronological order.

9. The method of claim 1, further comprising enabling at least one of said first and said second members to close said message to prevent posting of replies to said message.

10. The method of claim 1, further comprising enabling said members of said group to change a status of said message when a current status of said message is one of a predetermined plurality of statuses.

11. The method of claim 1, further comprising enabling only said second member handling said message to change a status of said message when a current status of said message is one of a predetermined plurality of statuses.

12. The method of claim 1, further comprising preventing said members of said group from changing a status of said message when a current status of said message is Closed.

13. The method of claim 1, further comprising enabling said second member to view a list of public messages currently assigned to said second member.

14. The method of claim 1, further comprising enabling said first member to view a list of public electronic messages originated by said first member.

15. The method of claim 1, further comprising enabling a member of said group to view a list of public electronic messages currently assigned to any other member of said group.

16. The method of claim 1, further comprising enabling a member of said group to view a list of public electronic messages currently assigned to members of said group.

17. A method comprising:
receiving from a member of a group a request for a list of pubic electronic messages assigned to members of said group; and
providing said list to said member of said group.

18. The method of claim 17, further comprising retrieving a plurality of public electronic messages assigned to said members of said group, said plurality of retrieved messages having a status other than closed.

19. The method of claim 17, further comprising retrieving a plurality of public electronic messages assigned to a selected member of said group, said plurality of retrieved messages having a status other than closed.

20. The method of claim 17, further comprising retrieving a plurality of public electronic messages assigned to said member of said group, said plurality of retrieved messages having a status other than closed.

21. The method of claim 17, further comprising retrieving a plurality of public electronic messages assigned to said members of said group, said plurality of retrieved messages having a status other than closed and having been assigned by said member requesting said list.

22. The method of claim 17, wherein said providing said list comprises displaying said retrieved public electronic messages in a list format to said member of said group.

23. The method of claim 22, wherein said displaying comprises displaying information regarding each of said retrieved public electronic messages, said information comprising information selected from the group consisting of a message type, a message status, a topic subject, and a username of a member of said group assigned to handle said respective public electronic message.

24. A method comprising:
receiving from a first member of a group a request to post a reply to a public electronic message assigned to a second member of said group;
receiving information from said first member regarding said reply; and
posting said reply for access by members of said group.

25. The method of claim 24, wherein posting said reply comprises posting said reply upon determining that a status of said public electronic message is other than closed.

26. The method of claim 24, further comprising displaying a user-interface to said first member for receiving said information from said first member.

27. The method of claim 24, wherein said receiving information comprises receiving information selected from the group consisting of a reply body, a status and a driver for said public electronic message.

28. The method of claim 24, wherein said posting said reply comprises posting said reply upon determining that a username of a driver for said public electronic message is valid.

29. The method of claim 24, wherein said posting said reply comprises posting said reply upon determining that prior to receiving said request, said public electronic message was assigned to said first member for handling.

30. The method of claim 24, further comprising:
receiving a request to update said posted reply;
receiving information regarding updating said posted reply; and
updating said posted reply for access by said members of said group.

31. The method of claim 30, wherein said updating said posted reply comprises updating said posted reply upon determining that said request to update was received from said first member.

32. A method comprising:
receiving from a first member of a group a request to post a public electronic message;
receiving information from said first member regarding said public electronic message, said information comprising information identifying a second member of said group for handling said public electronic message; and
posting said public electronic message for access by members of said group.

33. The method of claim 32, further comprising displaying a user-interface to said first member for receiving said information from said first member.

34. The method of claim 32, wherein said receiving information comprises receiving information selected from the group consisting of a topic subject, a topic body, a message type, a message status, and a driver for said public electronic message.

35. The method of claim 32, wherein said posting said public electronic message comprises posting said public electronic message upon determining that a username of a driver for said public electronic message is valid.

36. The method of claim 32, further comprising:
receiving a request to update said public electronic message;
receiving information regarding updating said public electronic message; and
updating said public electronic message for access by said members of said group.

37. The method of claim 36, wherein said updating said public electronic message comprises updating said public electronic message upon determining that said request to update was received from said first member.

38. A method for enabling communications between members of a group, comprising:
displaying a graphical user interface to a first member of said group;
enabling the receipt of a public electronic message from said first member; and
enabling the receipt of information regarding a second member of said group, said second member being assigned said public electronic message for handling.

39. The method of claim 38, further comprising enabling the receipt of information regarding a third member of said group, said public electronic message being assigned by said second member to said third member for handling.

40. The method of claim 38, further comprising enabling the receipt of an electronic reply to said public electronic message from any member of said group.

41. The method of claim 38, further comprising enabling the receipt of an updated electronic reply to said public electronic message.

42. The method of claim 38, further comprising presenting said public electronic message along with a plurality of electronic replies to said public electronic message in a predefined order to a member of said group.

43. The method of claim 38, further comprising enabling receipt of at least one instruction from at least one of said first and second members to close said message.

44. The method of claim 38, further comprising enabling receipt of information regarding a change in status of said message.

45. The method of claim 38, further comprising presenting to said second member a list of public electronic messages currently assigned to said second member.

46. The method of claim 38, further comprising presenting to said first member a list of public electronic messages originated by said first member.

47. The method of claim 38, further comprising presenting to a member of said group a list of public electronic messages currently assigned to any other member of said group.

48. The method of claim 38, further comprising presenting to a member of said group a list of public electronic messages currently assigned to members of said group.

49. A front message exchange system for enabling communications between members of a group, comprising:
a server; and
application logic operatively associated with said server and operable to:
enable a first member of said group to post a public electronic message; and
enable said first member to assign a second member of said group for handling said message.

50. The system of claim 49, said application logic further operable to enable said second member to reassign said message to a third member of said group for handling.

51. The system of claim 49, said application logic further operable to enable each member of said group to post electronic replies to said message.

52. The system of claim 51, said application logic further operable to enable each member of said group to edit only those replies posted by said respective member.

53. The system of claim 51, said application logic further operable to prevent each member of said group from editing their respective replies subsequent to posting of other replies.

54. The system of claim 51, said application logic further operable to prevent said first member from modifying said message subsequent to posting of replies to said message.

55. The system of claim 51, said application logic further operable to enable each member of said group to view said message along with a plurality of said replies to said message in a predefined order.

56. The system of claim 55, wherein said predefined order is a chronological order.

57. The system of claim 49, said application logic further operable to enable at least one of said first and said second members to close said message to prevent posting of replies to said message.

58. The system of claim 49, said application logic further operable to enable said members of said group to change a status of said message when a current status of said message is one of a predetermined plurality of statuses.

59. The system of claim 49, said application logic further operable to enable only said second member handling said message to change a status of said message when a current status of said message is one of a predetermined plurality of statuses.

60. The system of claim 49, said application logic further operable to prevent said members of said group from changing a status of said message when a current status of said message is Closed.

61. The system of claim 49, said application logic further operable to enable said second member to view a list of public messages currently assigned to said second member.

62. The system of claim 49, said application logic further operable to enable said first member to view a list of public electronic messages originated by said first member.

63. The system of claim 49, said application logic further operable to enable a member of said group to view a list of public electronic messages currently assigned to any other member of said group.

64. The system of claim 49, said application logic further operable to enable a member of said group to view a list of public electronic messages currently assigned to members of said group.
